(19) United States
(12) Patent Application Publication
(10) Pub. No.: US 2021/0367485 A1
(43) Pub. Date: Nov. 25, 2021

(54) Intelligent Automotive Component For Hybrid Vehicle

(71) Applicant: Clarence Wheeler, Atlanta, GA (US)

(72) Inventor: Clarence Wheeler, Atlanta, GA (US)

(73) Assignee: Nurosphere Inc., Atlanta, GA (US)

(21) Appl. No.: 17/367,507

(22) Filed: Aug. 10, 2021

Related U.S. Application Data
(63) Continuation-in-part of application No. 16/214,118, filed on Jan. 25, 2019, now Pat. No. 11,092,128.
Application No. 16/214,118 is a continuation-in-part of application No. 16/594,065, filed on Dec. 30, 2019, now Pat. No. 11,125,199.

(51) Int. Cl. H02K 11/30; H02K 3/24; H02K 3/50; H02K 7/00; H02K 9/19; B60L 50/64; B60K 1/00; B60L 15/20

(52) U.S. Cl. CPC H02K 11/30; H02K 3/24; H02K 3/50; H02K 7/006; B60K 2001/006; B60L 50/64; B60K 1/00; B60L 15/20; H02K 9/19

(57) ABSTRACT

An intelligent automotive component such as an fuel pump and electric steering gear for an hybrid vehicle. The intelligent automotive component having an power-link apparatus having an circuitry that furthers allocates and restricts power supply to one or more components of the intelligent automotive component. The intelligent automotive component comprises an control apparatus such as an key fob or external terminal that allows wireless communication between the intelligent automotive component and key fob.

### CROSS-REFERENCES TO RELATED APPLICATION

Not Applicable.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

### Field of the Invention

This invention relates to the field of automotive components and systems.

### Related Art

In electric vehicles (EV) and fuel cell vehicles when synchronous motors and high pressure pumps are used, components such as the stator of the motor and pumps or valves of the fuel cell system are traditionally controlled to obtain power via an battery, controller and an ignition to operate. Accordingly, various methods have conventionally been proposed to control power supply and distribution to these components. Specifically, disclosed in the current invention describes a automotive system having advantage features and implementation that introduces a innovated system and method for power supply to one or more components of an electric vehicle and fuel cell vehicle.

### BRIEF SUMMARY OF THE PRESENT INVENTION AND ADVANTAGES

The present invention discloses an fuel cell vehicle and electric vehicle having an intelligent automotive component. One aspect of the intelligent automotive component is to control an automotive component from a external apparatus such as an key fob. For instance, the intelligent automotive component of the electric vehicle and fuel cell vehicle may be but not limited to the electric motor and an high pressure pump which will be better described later in the current invention. Further, the intelligent automotive component include various internal and external components to preform an plurality of duties to keep the component operating efficiently. The intelligent automotive component can consist of an power-link apparatus circuitry configured to allocate or restrict an current to and from one or more components of the intelligent automotive component.

### BRIEF DESCRIPTION OF THE SEVERAL VIEWS OF THE DRAWINGS

A more complete understanding of the present invention is derived by referring to the detailed description and claims when considered in connection with the Figures, wherein like reference numbers refer to similar items throughout the Figures.

FIG. 1 is a block diagram describing the key fob.

FIG. 2 is a block diagram illustrating the power-link apparatus that performs power management according to an embodiment of the inventive concept.

FIG. 3a-3c shows an illustration of an fuel cell system having an intelligent automotive component to operate as described according to one embodiment.

FIGS. 4a & 4b shows an schematic diagram of an circuitry of an fuse box and fuse relay of the fuel cell system according to one embodiment.

FIG. 5a-5d shows an illustration of the circuitry of the power-link apparatus of the fuel cell vehicle according to another embodiment.

FIG. 6 shows an diagram of the power-link apparatus circuitry of the fuel cell vehicle according to another embodiment.

FIG. 7 is an block diagram of an motor drive system for an electric vehicle having the intelligent automotive component according an embodiment of the present invention.

FIGS. 8a & 8b shows an schematic diagram of an circuitry of the fuse box and fuse relay of the electric vehicle according to another embodiment.

FIG. 9a-9d shows an illustration of the circuitry of the power-link apparatus of the electric vehicle according to one embodiment.

FIG. 10 shows an diagram of the power-link apparatus circuitry of the fuel cell vehicle according to another embodiment.

FIG. 11 illustrates an cross-sectional view of electric power steering gear having the intelligent automotive component for the electric vehicle.

FIG. 12 illustrates an stator of the electric power steering gear having the intelligent automotive component and one or more other components.

FIG. 13 is an flowchart of a process for remotely activating the intelligent automotive component in accordance with an exemplary embodiment of the present invention.

FIG. 14 is an flowchart of a process for remotely deactivating the vehicle intelligent automotive component in accordance with an exemplary embodiment of the present invention.

### DESCRIPTION OF THE EMBODIMENT(S)

The numerous innovative teachings of the present invention will be described with particular reference to the preferred embodiments disclosed herein. However, it should be understood that the embodiments described provided only a few examples of the many advantages uses and innovative teachings herein. In general, statements made in the specifications of the present application do not necessarily delimit any of the various claimed inventions. Moreover, some statements may apply to some inventive features, but not to others. The following described automotive components and systems may be used to preform a duty or operative take and may communicate and receive data from an external terminal to preform a task.

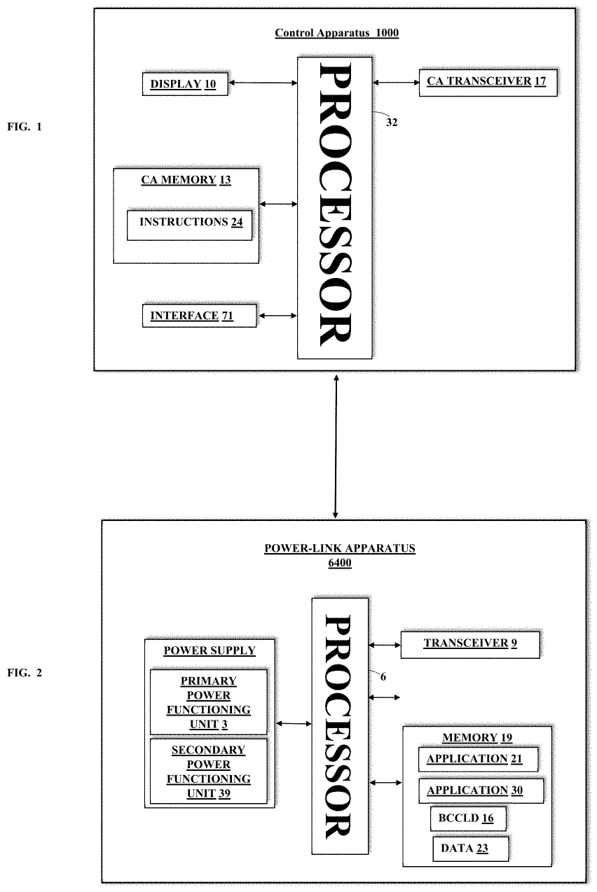

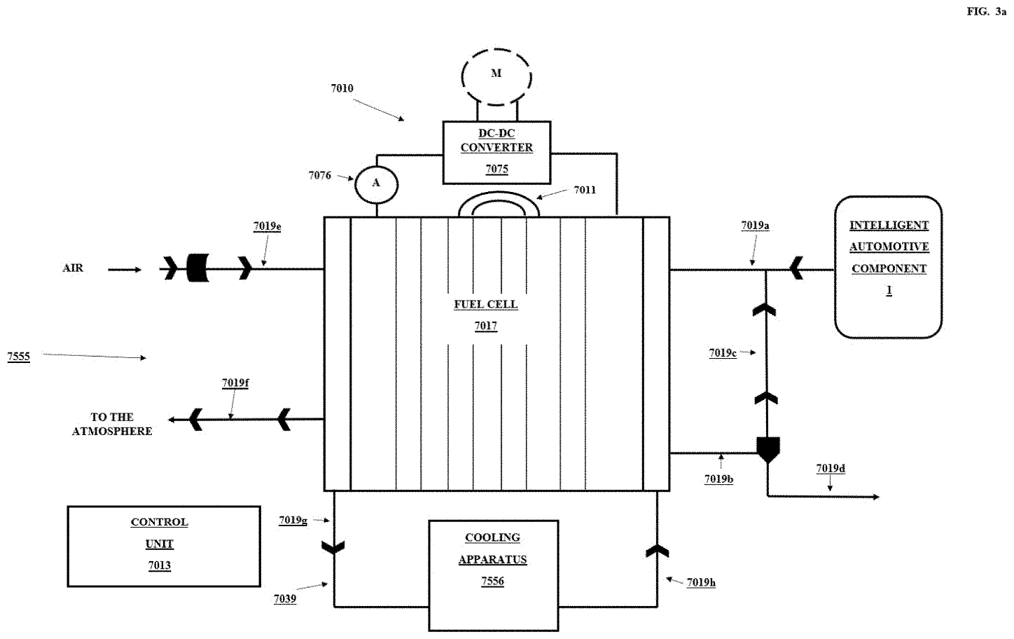

FIG. 1 illustrates a functional block diagram of control apparatus 1000 for remotely activating and deactivating intelligent automotive component(s), in accordance with an exemplary embodiment of the present invention.

As shown in FIG. 1, control apparatus 1000 comprises one or more CA processor(s) 32, CA transceiver 7, display 10 and one or more memory(s) 13. Control apparatus 1000 illustrated in the present discloser may be better identified as a key fob, smart-phone or any other external apparatus configured to distribute and obtain one or more signal wirelessly known to one skilled in the art(s).

Control apparatus 1000 may be configured to execute many task and operations in order to distribute one or more remote activation or deactivation request signal(s) to intelligent automotive component via CA transceiver 7 in order to activate or deactivate intelligent automotive component(s).

Control apparatus 1000 may further be configured to obtain one or more states (e.g., and status of intelligent automotive component via CA transceiver 7 and display the state on display 10. Control apparatus 1000 comprises one or more CA processor(s) 32 configured to provide instructions to CA transceiver 7 to distribute one or more remote activation or deactivation request signal(s) to intelligent automotive component(s). CA processor(s) 32 is further configured to provide instructions for displaying one or more notification on display 10, in response to obtaining an component state signal (CSS) via intelligent automotive component notifying the user the state (e.g., activation or deactivation) of the one or more intelligent auto motive component(s) or one or more electrical components (e.g., battery) of intelligent automotive component(s).

CA processor(s) 32 may also execute one or more program(s) 24 stored on memory(s) 13 that controls the overall operations of processing system 1000. CA processor(s) 32 may comprise any type of processor or multiple processors, single integrated circuits such as a microprocessor, or any suitable number of integrated circuit devices and/or circuit boards working in cooperation to accomplish the functions of a processing unit. Specifically, CA transceiver 7 can be configured to distribute one or more activation or deactivation request signal(s) to intelligent automotive component(s) under the control of one or more CA processor(s) 32. CA transceiver 7 can also be configured to obtain one or more component state signal(s) (CSS) indicating the status of intelligent automotive component(s).

Control apparatus 1000 comprise one or more memory(s) 13 that stores one or more program(s) 24 that executes one or more instructions and processes. Memory(s) 13 may further store various types of data to support the processing, control, or storage requirements of control apparatus 1000. Examples of such data may include an operating program, software instructions for controlling control apparatus 1000 execution commands etc. Memory(s) 13 may be implemented using any type of volatile and non-volatile memory or storage devices. Such devices may include random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, cardtype memory, or other similar memory or data storage device or any type of suitable memory. Memory(s) 13 stores an application 24 that, when processed by one or more CA processor(s) 32, enables CA processor(s) 32 to: obtain an component state signal (CSS) via intelligent automotive component, in response to obtaining component state signal (CSS) application 24 is configured to display the contextual status of intelligent automotive component associated with the obtained component state signal (CSS) on display 10. For instance, the state of intelligent automotive component may be displayed on display 10 labeled “IAC Activated or IAC Deactivated” other suitable identifications may be displayed to notify the user the state of intelligent automotive component.

Furthermore, memory(s) 13 storing application 24 is an example of a computer program product, comprising a non-transitory computer usable medium having a computer readable program code adapted to be executed to implement a method, for example a method stored in application 24. Display 10 that may include an panel. The panel and the touch panel may be configured with one module. Display 10 further includes a control circuit for controlling the panel. Display 10 may be implemented using known display technologies such as a liquid crystal display (LCD), a thin film transistor-liquid crystal display (TFT-LCD), an organic light-emitting diode display (OLED), active matrix organic light-emitting diode (AMOLED) or a three-dimensional display. Display 10 may further be coupled to processing system 5, in order to obtain instructions from CA processor(s) 32. Control apparatus 1000 comprises interface 2 that may allocate communication to an processing system via an user input, a system operator, and/or another computer system, and can be implemented using any suitable method and apparatus.

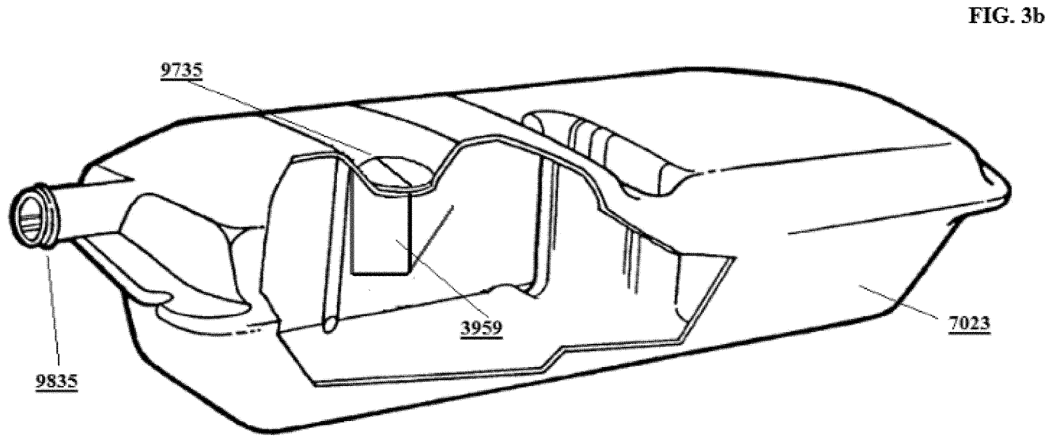

FIG. 2 illustrates a functional block diagram of power-link apparatus 6400 of intelligent automotive component 1 for activation and deactivation the intelligent automotive component 1, in accordance with an exemplary embodiment of the present invention.

Intelligent automotive component(s) (IAC) (e.g., electronic machine) 1 comprises power-link apparatus 64 disposed within at least one area and coupled to at least one component of intelligent automotive component 1 that controls the activation and deactivation operations. Specifically, power-link apparatus 6400 includes processor(s) 6, memory(s) 19, transceiver 14, an power supply comprising primary power functioning unit 3 and secondary power functioning unit 39.

IAC processor(s) 6 can be configured to determine if at least an remote activation or deactivation request signal has been obtained via control apparatus 1000, distributes one or more component state signal(s) (CSS) to CA transceiver 7 notifying the user the state (e.g., activated or deactivated) of intelligent automotive component(s) 1 thereof. In addition, processor(s) 6 execute one or more programs stored on memory(s) 19 that controls the overall operations of intelligent automotive components 1.

CA processor(s) 6 may comprise any type of processor or multiple processors, single integrated circuits such as a microprocessor, or any suitable number of integrated circuit devices and/or circuit boards working in cooperation to accomplish the functions of a processing unit. Further, intelligent automotive component(s) comprises an transceiver 14 configured to distribute an components state signal (CSS) and/or instructions to control apparatus 1000 under the control of processor(s) 6. Transceiver 14 can be configured to obtain one or more activation or deactivation request signal(s) from control apparatus 1000 via under the control of processor(s) 6.

Memory(s) 19 stores application 21 that executes one or more instructions and processes. The memory(s) 19 may also stores various types of data to support the processing, control, or storage requirements of intelligent automotive component 1. Examples of such data may include an operating program, software instructions for controlling intelligent automotive component 1 execution commands. Memory(s) 19 may be implemented using any type of volatile and non-volatile memory or storage devices. Such devices may include random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, cardtype memory, or other similar memory or data storage device or any type of suitable memory.

Power-link apparatus 6400 comprises primary power functioning unit 3 configured to distribute voltage power (e.g., current) to processing circuit 44 and the one or more electrical components of power-link apparatus 6400 via the automobile battery.

Power-link apparats 6400 comprises secondary power functioning unit 39 configured to allocate or restrict power-signals (e.g., current) to high pressure pumps and/or stator coils upon processor 6 generating and distributing a first switch control signal (FSCS) to power functioning controller 42.

Primary and secondary power functioning unit (3, 39) may be the like(s) of an power management module, power management IC (PMIC), power control circuit or any known power control system known to one skilled in the art(s). In addition, primary and secondary power function unit (3, 39) circuits may comprises transistor, resistors, capacitor, voltage regulator, logic gates, inverters, etc. configured to obtain, hold and distribute an suitable amount of operation power to the one or more electrical components.

Various embodiments described herein may be implemented in a computer-readable medium using computer software. The various embodiments may also be implemented in hardware. A hardware implementation may be implemented using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein. Some embodiments are implemented by processor(s) (6, 32) and power functioning controller 20. A software implementation of the embodiments described herein may be implemented with separate software modules, such as procedures and functions, each of which perform one or more of the functions and operations described herein. The software code may be implemented with a software application written in any suitable programming language and may be stored in memory(s) (13, 19) for execution by the one or more processor(s) (6, 32) and/or power functioning controller (20, 42).

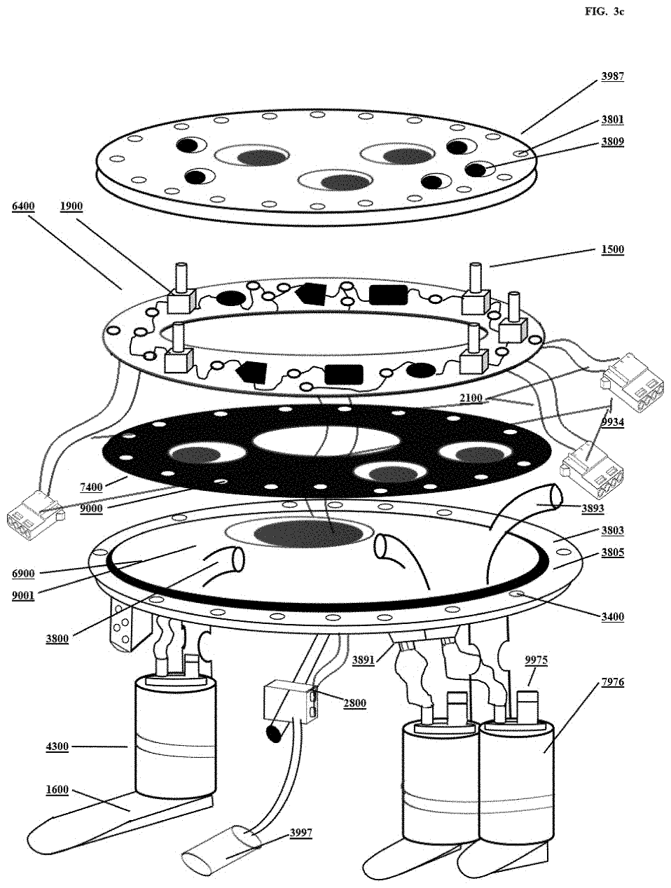

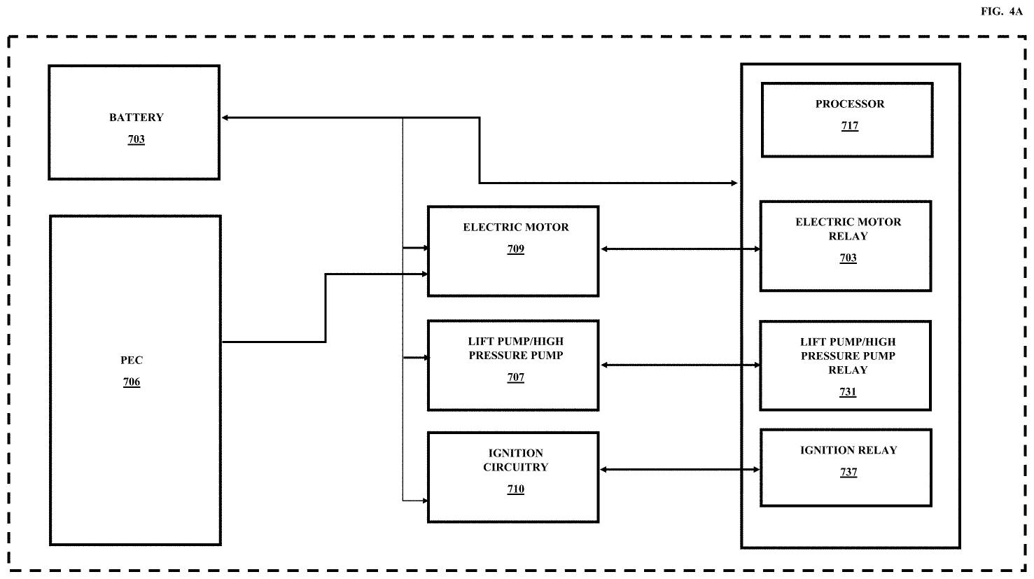

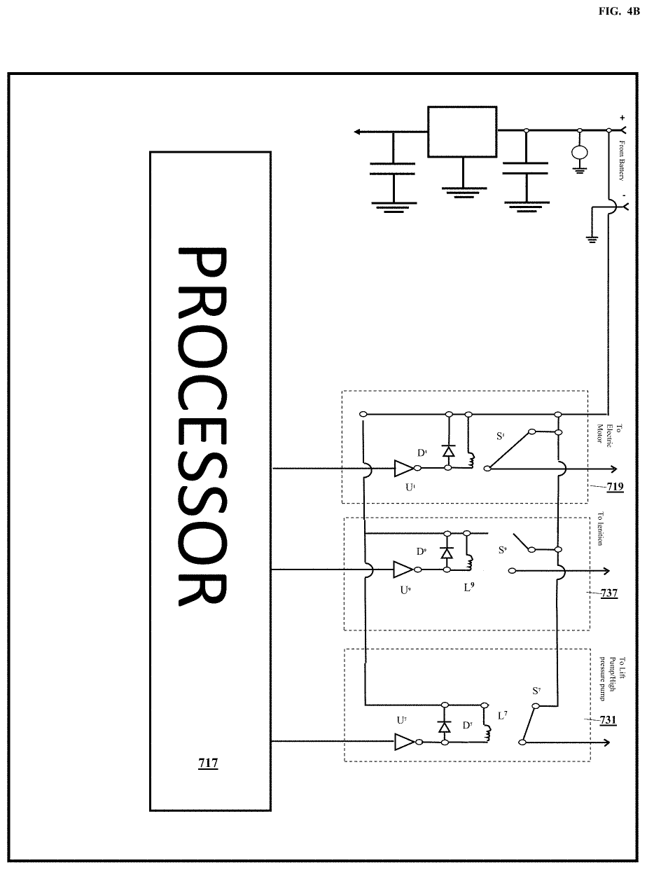

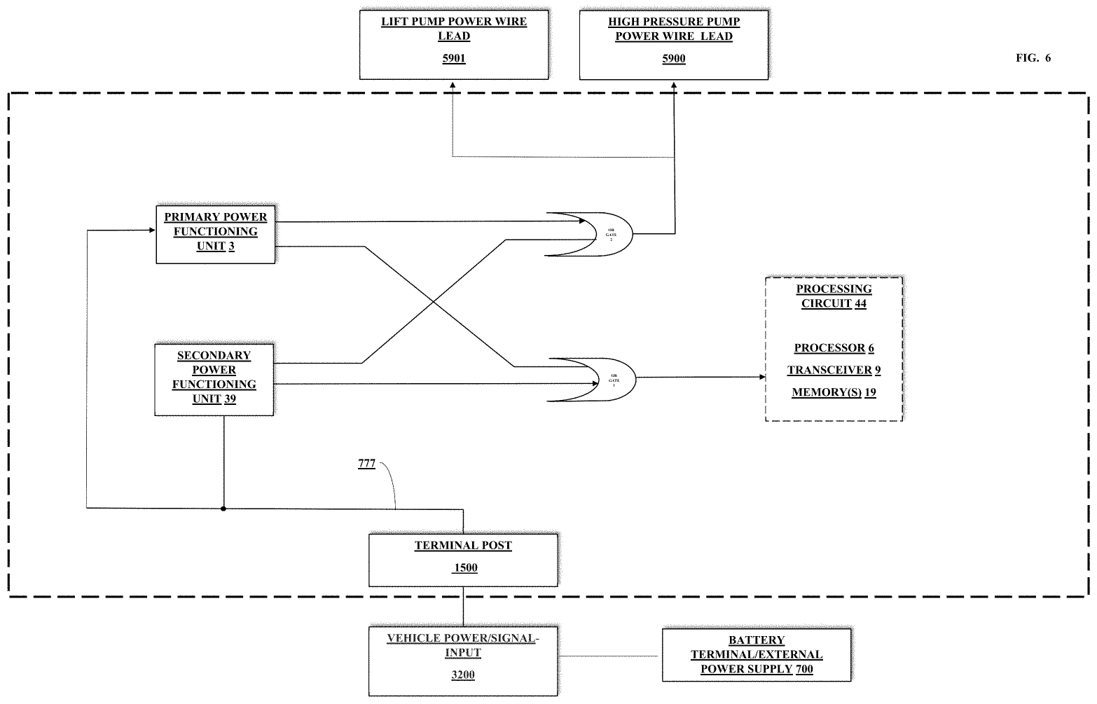

FIG. 3a-3d illustrates a block diagram configuration of an fuel cell system 7000 having an intelligent automotive component 1 (e.g., comparable of an cfc unit for an fuel cell vehicle) for an fuel cell vehicle. FIG. 6B shows a perspective view of the tank 7023 of intelligent automotive component 1 according to one embodiment. FIG. 6C shows a perspective view of housing cover 7023 and housing base 3803 of intelligent automotive component 1 according to another embodiment.

The fuel cell system 7000 includes power supply system 7010, cooling circulation system 7039, control unit 7013, an fuel cell 7017, one or more fuel supply system 7019 and intelligent automotive component 1.

The fuel cell 7017 consist of a polymer electrolyte fuel cell and an plurality of stacked unit cells 7011 for generating electrical power by electrochemical reaction of a fuel gas and a oxidizing gas. The fuel cell 7017 is not limited to the polymer electrolyte fuel cell but may be any other various type of fuel cell 7017.

One or more fuel discharge passages 7019a-7019d can be configured to distribute fuel to fuel cell 7017 and also output excess fumes, gasses and water through an exhaust pipe or system of the vehicle. The fuel discharge passages 7019a-7019d can consist of one or more fuel lines coupled to high pressure pumps for supplying hydrogen fuel to fuel cell 7017, one or more shutoff valves, injectors, gas liquid separator, circulation pump, purge valve, fuel gas supply passage and one or more fuel gas discharge systems.

The fuel discharge passages 7019a for supplying hydrogen fuel to fuel cells 7017 via high pressure pumps. The fuel discharge passages 7019b for obtaining hydrogen fuel from fuel cells 7017, also to separate and distribute water from the hydrogen fuel to fuel discharge passage 7019c, also to distribute hydrogen fuel from fuel cell 7017 back to fuel discharge passage 7019d after separation of the water from the hydrogen fuel to fuel discharge passage 7019c.

Reacting discharge system 7555 can be configured to supply and discharge the oxidizing gas to and from the fuel cells 7017. Reacting discharge system 7555 comprise reacting discharge passage 7019e for intaking air from exterior of vehicle and supplies this air throughout the reacting discharge passage 7019e. Reacting discharge passage 7019f for outputting back pressure of fuel cell 7017 to exterior of vehicle. Reacting discharge system 7555 can consist of an air compressor and one or more valves to accomplish the above mentioned tasked. Cooling circulation system 7039 can be configured to supply an cooling medium to the fuel cell 7017 therefor regulating the temperature of fuel cells 7017. Cooling circulation system 7039 can consist of cooling apparatus 7556 coupled to cooling discharge passage 7019g and cooling supply passage 7019h to cool down the cooling medium from cooling discharge passage 7019g. Cooling circulation system 7039 can consist of one or more cooling circulation pump and one or more sensors.

Fuel cell system 7000 also consist of power supply system 7010 for supplying electric power from fuel cell 7017 to motor M. Power supply system 7010 DC-DC converter 7075 communicable coupled to fuel cell 7017 via current collector to control the output voltage distribute to the motor M, and an ammeter 7076 for measuring the current value of fuel cell 7017.

Control unit 7013 is communicable coupled to DC-DC converter 7075 search pumps 7797 and high pressure pumps 7976 (e.g., intelligent automotive component 1) and many other components of system 7000.

Specifically, intelligent automotive component 1 (e.g., cfc unit) includes an 10 to 30 kg tank 7023 consist of an opening 9735 for receiving an substantially cylindrical-shaped opening housing 6100, filler inlet 9835 for refueling the tank 7023 and an search tank 3959. Search tank 3959 can be a 2 to 5 liter tank configured to obtain fuel from tank 7023 via lift pump 4300.

Search tank 3959 can be intergraded in tank 7023 only covering an partial region of tank 7023.

Search tank 3959 can also cover approximately a quarter of opening 9735 so that high pressure pumps 7976 can assemble within surge tank 3959. Surge tank 3959 can be configured to contain in the range of 2 to 5 liters of fuel.

Housing cover 3987 includes one or more openings 3801 boarding a rim region for coupling housing cover 3987 to flange 3805 of housing base 3803 via screws, and one or more openings 3809 for receiving one or more terminal post of power-link apparatus 6400. Housing cover 3987 can be formed of an spherical or any other type shape. Housing base 3803 is also formed of an spherical or any other type shape. Housing base 3803 is formed having an recess 6900 constituting an concave opening consisting of an horizontal flange 3805 projecting inward away from rim of housing base 3803 for seating power-link apparatus 6400 thereon to housing base 3803. Flange 3805 can also consists of one or more small openings 9000 for coupling power-link apparatus 6400 to housing base 3803 via screws. Alternative, power-link apparatus 6400 can be coupled to housing base 3803 via adhesive. Recess region 6900 of housing base 3803 also includes an plurality of larger openings 9001 spaced respectively at an base surface allocating wire lead(s) 2100 and electric connector of power-link apparatus 6400 to deviate recessed region 6900.

Housing base 3803 contains return inlet 1200, output inlet 3800, one or more openings and various other components coupled thereon.

Recess region 6900 of housing base 3803 comprises silicone insert 7400 that arranges underneath power-link apparatus 6400 within recess region 6900. Silicone insert 7400 respectively corresponds with the dimensions of recess region 6900 assembling on flange 3805 of housing base 3803. Silicone insert 7400 comprises an plurality of small openings 9000 matching the pattern of recess region 6900 threaded openings 3400, silicone insert 7400 base region also consist of an plurality of openings 9934 matching the pattern of recess region 6900 base region small openings 9000 so that wiring leads 2100 of power-link apparatus 6400 can deviate recess region 6900 of housing base 3803 and join with one or more components of intelligent automotive component 1.

Bottom surface of housing base 3803 consist of one or more inlets 3891 coupled to high pressure pumps 7976 that corresponds with output inlet 3893 for supplying fuel to fuel cells 7017. Bottom surface of housing base 3803 also consist of one or more inlets 3891 coupled to lift pumps 4300 that corresponds with return inlet 3800 for supplying fuel to search tank 7023.

Return inlet 3800 can be configured to obtain fuel from tank 7023 via lift pump 4300 and also return excess fuel from search tank 3959 back to tank 7023. Output inlet 3893 sends fuel to fuel cell 7011 via high pressure pumps 7976.

An cylinder shape lift pump 4300 includes features as of the impeller arranged between a casting body, a pump cover, and the likes, lift pump 4300 convey the required quantity of fuel from tank 7023 to search tank 3959. One or more cylinder shape high pressure pumps 7976 also includes features as of the impeller arranged between a casting body, a pump cover, and the likes, high pressure pump 7976 convey the required quantity of fuel from search tank 3959 to fuel cell 7017 via fuel discharge passage 7019a at the necessary pressure. Output inlet 3893 can be coupled to fuel discharge passage 7019a via one or more hoses or line.

Lift pump 4300 and high pressure pump 7976 includes electrical connector port 9975 communicable coupled to electrical connector 9790 of power-link apparatus 6400 for obtaining and distributing one or more signals (e.g., power-signal and or data signals) to and from each other.

Fuel level sensor 2800 used to indicate the level of fuel contained in tank 7023, sending float 3997 is typically accompanied with sending unit and may send the fuel level of tank 7023 to your fuel gauge. High pressure pumps 7976 and lift pumps 4300 include fuel filter 1600 to filter derbies, dirt, and rust particles from the fuel to give a smooth efficient ride.

Signifying, power-link apparatus 6400 body forms the likes of an printed-circuit board. Further, power-link apparatus 6400 can use the likes of MOSFETS to allocate an electrical currents to one or more components. Power-link apparatus 6400 comprise of one or more terminal post 1500 (e.g., consisting of at least one constant and ground high current terminal post 1500) coupled to a top surface of power-link apparatus 6400 configured to obtain an power signal (e.g., current or signal) from vehicle power/signal-input 3200 (e.g., high power gage, terminal wire or etc.) this can be accomplished by soldering block connector 1900 to power-link apparatus 6400 and coupling terminal post 1500 to terminal block connector 1900. The one or more terminal block connectors 1900 can also be coupled to a conductor and/or power signal path of power-link apparatus 6400 via an adhesive or soldering process.

Wiring lead(s) 2100 of power-link apparatus 6400 are joined to an power-signal path or at lease one component of power-link apparatus 6400 circuitry, further the wires can be made of resin-molding. Wiring lead(s) 2100 are the like(s) of an sender ground/return terminal wire, a signal sender terminal wire, a pump power terminal wire, and pump ground terminal wire. Wiring lead(s) 2100 preform task as to sending or receiving signal(s) and power to components of intelligent automotive component 1, automobile computer and one or more sending unit(s) of the vehicle. Wiring leads 2100 consist of electrical connector 2300 configured to be coupled to electrical connector 2300 of lift pump 4300, high pressure pumps 7976 and fuel level sensor 2800.

Further, at lease one terminal wire(s) is respectively coupled to the fuel level sensor 2800 in conjunction with sending float 3900 for obtaining an the level capacity signal(s) so that processor 6300 of power-link apparatus 6400 can output(s) fuel level capacity signal(s) to the vehicle computer system, or at lease one sending unit of the vehicle via vehicle power/signal-input 3200 being coupled to terminal post 1500.

Further, electrical connector 9934 of power-link apparatus 6400 comprises at lease one wire(s) lead 2100 affixed to one or more high pressure pumps 7976 configured to output(s) regulated power signals (current(s)) in response to power-link apparatus 6400 obtaining an remote activation request signal (RARS) via control apparatus 1000 and secondary power functioning unit 39 distributing power signals (e.g., current) to pump power wire lead 5900 based upon processor(s) 6 distributing an first switch control signal (FSCS) to power functioning controller 42, power functioning controller 42 is configured to generate and distribute an power signal to switch circuit 3 41 to close the circuitry of power signal path 974 in order to allocate power signal (e.g., current) to pump power wire lead 5900 via or gate 2.

Electrical connector 9934 comprises at lease one wire(s) lead 2100 affixed to one or more high pressure pumps 7976 configured to output(s) an regulated power signal (current(s)) in response to throttle position, engine speed, or fuel injector dwell time, where the regulated power signal (voltage(s)) output to one or more high pressure pumps 7976 is raised or lowered based upon an higher or lower psi is required to pump fuel to fuel cell 7011 depending on the state of the throttle position, engine speed, or fuel dwell time.

Electric connector 9934 includes at lease one terminal wire is respectively affixed to high pressure pump 7976 configured to output an regulated power signal (current(s)) in response to Obtaining a remote activation or deactivation request signal by processor 6300, where an plurality of switch(s) of a switch circuitry of power-link apparatus 6400 is at an open or closed state allocating or restricting power signals (current(s)) to one or more high pressure pumps 7976.

For example, when power-link apparatus 6400 obtains an remote activation request signal enable mode an regulated power (voltage(s)) is then output to one or more high pressure pumps 7976 via the terminal wire. When power-link apparatus 6400 obtains an remote deactivation request signal the regulated power signal (current(s)) is further restricted at one or more switch circuitry's of power-link apparatus 6400 restricting regulated power (voltage(s)) to be output to one or more high pressure pumps 7976 via terminal wire.

Further, the signals distributed through wiring lead(s) 2100 can be analog, digital, pulse modulated and is not limited to any other signal(s) configuration known to one skilled in the art(s).

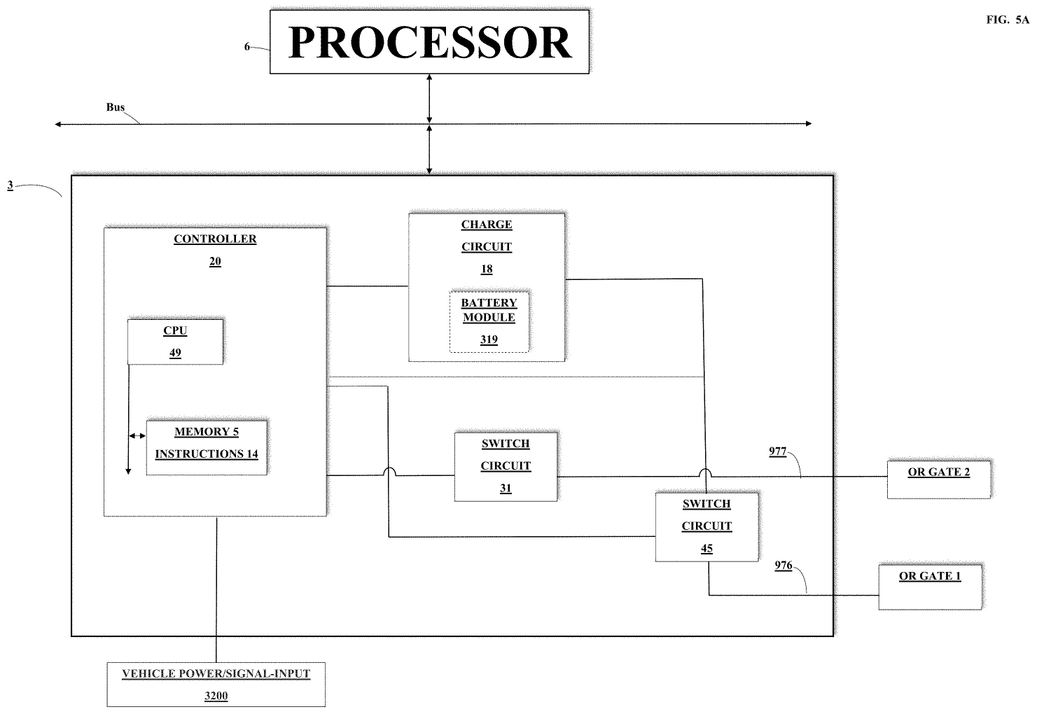

FIGS. 4a & 4b shows a block diagram of an fuel and relay box of an fuel cell vehicle. Vehicle includes battery 703, power electronics controller (PEC) 706, electric motor circuit (IAC) 709, lift pump/high pressure pump circuit (IAC) 707 and ignition circuit 710. Fuel box 721 can include processor 717, electric motor relay 719, lift pump/high pressure pump relay 731 and ignition circuit relay 737. In addition, processor 717 can be coupled to electric motor relay 719, lift pump/high pressure pump relay 731 and ignition circuit relay 737.

In such implementation battery 703 can be coupled to electric motor (IAC) 709, lift pump/high pressure pump (IAC) 707 and ignition circuit 710. Battery 703 can be a standard 12V or 24V vehicle battery, auxiliary battery or traction battery pack. Power electronics controller (PEC) 706 can be coupled to engine starter motor (IAC) 709, fuel pump (IAC) 707 and ignition circuit 710.

Further, power electronics controller (PEC) 706 can be configure to manage the flow of electrical energy delivered by fuel cells and the traction battery, control the speed of the electric traction motor and torque it produces.

Electric motor relay 719 can comprise a processor controller and relay system controlled by processor 717, and can be coupled to a input of electric motor (IAC) 709. Electric motor relay 719 can be configured connect electric motor (IAC) 709 to positive terminal of battery 703 via an high power gauge or terminal wire.

And on, electric motor relay 719 is preferably configured to allow an power signal to be sent to electric motor (IAC) 709 to perpetually keep currents supplied to power-link apparatus when the ignition is at the OFF, RUN, START position or if the push button isn't pressed, and to start the vehicle when the ignition is at the START position. Electric motor relay 719 can include a operational amplifier U¹ connected to a diode and inductor L¹, with a switch connected thereto, such that inductor L¹ is configured to control a state of switch S¹ to keep at a closed position to perpetually allocate power (e.g., current) to electric motor (IAC) 709. For example, on conventional electric vehicles (EV) and hybrid vehicles inductor L¹ is configured to control a state of switch S¹ of electric motor relays 719 to a open position restricting power (e.g., current) to a electric motor when the ignition is turned to the OFF position, and inductor L¹ is configured to control a state of switch S¹ to the close position allocating power to the electric motor when the ignition is turned back to the ACC, RUN or SART position. Whereby as described in the current invention inductor L¹ is configured to control a state of switch S¹ to the close position at all times weather the position of the ignition is at the OFF, ACC, RUN, START position or if the ignition push button hasn't been pressed in order to allocate power (e.g., current) to the power-link apparatus in order to power the power-link apparatus, and to allocate an higher power to energize the coils of electric motor (IAC) 709 when the ignition is turned to the START position or when the ignition push button has been pressed. However, lift pump/high pressure pump relay 731 can comprise processor 717 and relay system to couple an terminal of lift pump/high pressure pump (IAC) 707 to the positive terminal of battery 703 or to the ground circuit of the vehicle. Ignition circuit relay 737 can comprise processor 717 and a relay system to activate ignition circuit 710. Ignition circuit relay 737 can include an operational amplifier U⁹ connected to diode D⁹ and inductor L⁹, with switch S⁹ connected thereto, such that inductor L⁹ can control whether or not switch S⁹ is opened or closed.

Further, lift pump/high pressure pump relay 731 is also preferably configured to allow a power signal to be sent to lift pump/high pressure pump (IAC) 707 to perpetually keep currents supplied to power-link apparatus when the ignition is at the OFF, RUN, START position or if the ignition push button hasn't been pressed. Lift pump/high pressure relay 731 can include an operational amplifier connected to diode D⁷ and an inductor L⁷, with switch S⁷ connected thereto, such that inductor L⁷ is configured to control a state of switch S⁷ to keep at a closed position to perpetually allocate power to lift pump/high pressure pump (IAC) 707. For example, on electric vehicle (EV) and hybrid vehicles inductor L⁷ is configured to control a state of switch S⁷ of lift pump/high pressure pumps relays to a open position restricting power (e.g., current) to the lift pump/high pressure pump when the ignition is turned to the OFF position or ignition push button hasn't been pressed, and inductor L⁷ is configured to control a state of switch S⁷ to the close position allocating power signals to the lift pump/high pressure pumps when the ignition is turned back to the ACC, RUN or START position. Whereby as described in the current invention inductor L⁷ is configured to control a state of switch S⁷ to the close position at all times weather the position of the ignition is at the OFF, ACC, RUN, START position or if the ignition hasn't been pressed.

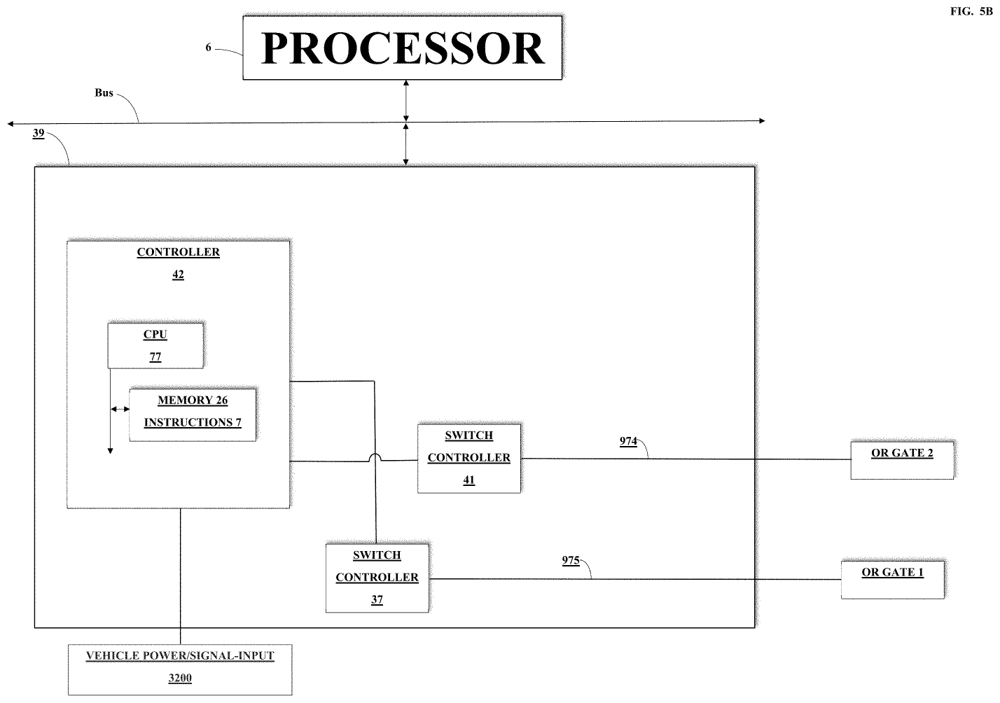

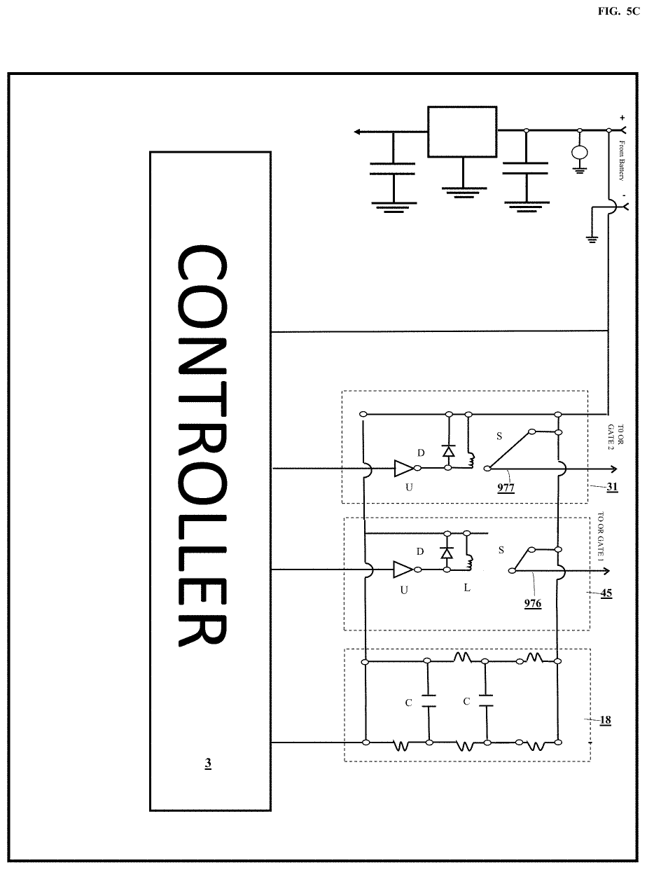

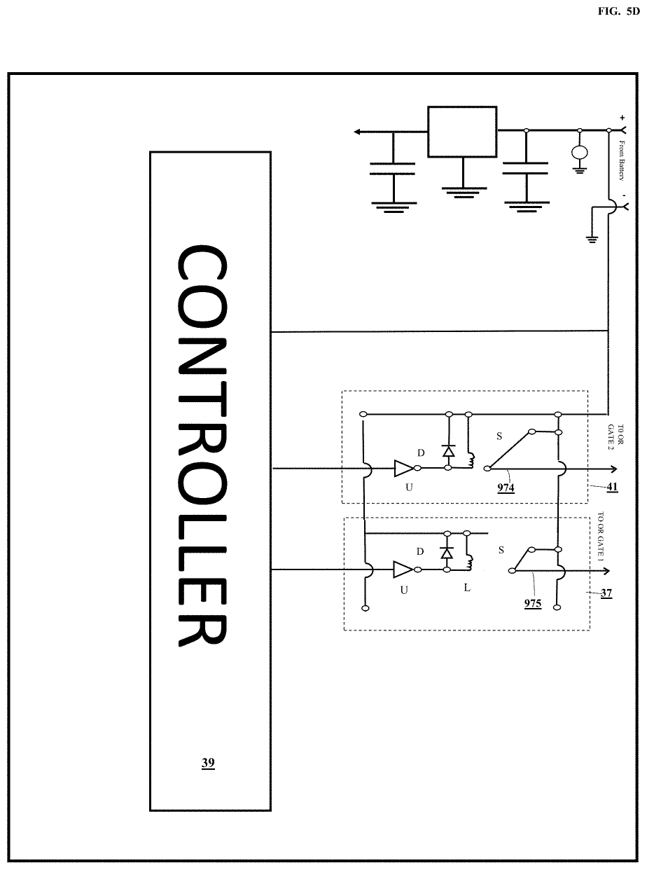

Accordingly FIG. 5a-5d is an illustration of the power supply circuit of power-link apparatus 6400 of intelligent automotive component (e.g., cfc unit) 1 for fuel cell system, primary power functioning unit 3 is configured to distribute operation power (e.g., current) to processing circuit 44 via or gate 1.

Secondary power functioning unit 39 is configured to distribute power-signals (e.g., current) to high pressure pump power wire lead 5900 and lift pump power wire lead 5901 to distribute hydrogen fuel to fuel cell 5017 to start the vehicle via or gate 2 in response to processor(s) 6 obtaining remote activation request signal and the user of the vehicle turning the ignition/push button to the start position, and can also restrict power-signals (e.g., current) to high pressure pump power wire lead 5900 and lift pump power wire lead 5901 in response to processor(s) 6 obtaining remote deactivation request signal, via control apparatus 1000.

Power-link apparatus 6400 comprises bus 1001 for connecting primary power functioning unit 3 and secondary power functioning unit 39 to processor(s) 6 and other electrical components for delivering one or more communication signals (e.g., switch control signals, messages, data or instructions) between the components. Primary power functioning unit 3 comprises power functioning controller 20, switch circuit 2 31, switch circuit 6 45 and charge circuitry 18. Power functioning controller 20 is configured to control one or more task operations of primary power functioning unit 3 such as controlling the overall aspect of allocating and restricting of power of switch circuits.

Power functioning controller 20 configured to stabilize input power (e.g., current) supplied by vehicle power/signal-input 3200 via battery terminal.

Primary power functioning unit 3 comprises switch circuit 6 45 having duties of switching between opening and closing the circuitry of power signal-path 976 in order to allocate or restrict operational power-signals (e.g., current) to processing circuit 44 via or gate 1, and switch circuit 2 31 can having duties of switching between opening circuitry of power signal path 977 to allocate or restrict voltage power (e.g., current) to high pressure pump power wire lead 5900 via or gate 2.

Switch circuitry 6 45 and switch circuit 2 31 can be a switching circuitry having an operational amplifier U connected to a diode D and an inductor L, with at least one switch S connected thereto, such that inductor L can control whether or not switch is opened or closed base upon a change of resistance of power-signals (e.g., current) suppled to switch circuitry 6 45 and switch circuit 2 31 under the control of power functioning controller 20. For instance, inductor L of switch circuitry 6 45 and switch circuit 2 31 can be configured control the closing of switch S in order to allocate power signals (e.g., current) based upon power functioning controller 20 distributing power signals (e.g., current) to switch circuitry 6 45 and switch circuit 2 31 and the power signals (e.g., current) energizing the coils of inductor L attracting the switch S to close the circuit of respective power signal paths respectively. And the inductor L of switch circuitry 6 45 and switch circuit 2 31 can be configured control the opening of switch S to restrict power (e.g., current) based upon power functioning controller 20 not distributing power signals (e.g., current) to switch circuitry 6 45 and switch circuit 2 31 this causes the coils of inductors L to not be energized and retracting the switch S to open the circuit of respective power signal paths respectively FIG. 5C.

Primary power functioning unit 3 comprises charge circuit 18 having duties of distributing operational power (e.g., current) to processing circuit 44 via power signal path 976 via or gate 1. Charge circuit 18 consist of battery module 319 having an battery, controller and one or more memory's for suppling operational power (e.g., current) to processing circuit 44 when the vehicle is on or off.

Power functioning controller 20 comprises Central Processing Unit (CPU) 49 that comprises one or more cores. Power functioning controller 20 comprises Random Only Memory (ROM) 50 for storing one or more control programs to control the one or more switch circuits (e.g., distributing power signals (e.g., current)) in response to obtaining an switch control signal via processor(s) 6. Power functioning controller 20 also comprises Random Access Memory (RAM) 51 for storing signals and data obtained by processor(s) 6, or for use as an memory space for an operation preformed by primary power functioning unit 3. CPU 49, ROM 50 and RAM 51 may be interconnected via an internal bus.

Secondary power functioning unit 39 comprises power functioning controller 42, switch circuit 3 41 and switch circuit 5 37.

Secondary power functioning unit 39 comprises switch circuit 3 41 having duties of switching between opening or closing the circuitry of power-signal path 974 in order to allocate or restrict power-signals (e.g., current) to high pressure pump power wire lead 5900 and lift pump power wire lead 5901 via or gate 2 in response to processor 6 obtaining a remote activation or deactivation request signal via control apparatus 1000.

Switch circuit 5 37 can have duties of switching between opening or closing the circuitry of power signal path 975 on order to allocate or restrict power signals (e.g., current) to processing circuit 44 or gate 1.

Switch circuitry 3 41 and switch circuit 5 37 can be a switching circuitry having an operational Amplifier U connected to a diode D and an inductor L, with at least one switch S connected thereto, such that inductor L can control whether or not switch S is opened or closed. Controller 42 can be configured to control one or more task operations of secondary power functioning unit 39 such as controlling the switching of the switch circuit respectively FIG. 5D.

Controller 42 also comprises Central Processing Unit (CPU) 52 that comprises one or more cores. Random Only Memory (ROM) 53 can store one or more control programs to control the one or more switch circuits, in response to obtaining a switch control signal via processsor(s) 6. Random Access Memory (RAM) 54 can store data and instructions to execute a task upon obtaining a remote activation or deactivation signal, or for use as an memory space for an operation preformed by secondary power functioning unit 39.

CPU 52, ROM 53 and RAM 54 may be interconnected via an internal bus.

As illustrated, primary power functioning unit 3 and secondary power functioning unit 39 is coupled to processor(s) 6 via bus 1001 and whereby can be configured to obtain instruction and signals to execute one or more task.

The OR gates used in the present invention is an digital logic gate that implements logical disjunction it behaves according to the truth table; A HIGH output (1) results if one or both of the inputs to the gate are HIGH (1). If neither input is high, a LOW output (0) results. In another sense, the function of OR effectively finds the maximum between two binary digits, just as the complementary and function finds the maximum.

According to the present invention, during activation of intelligent automotive component 1 power-signals (e.g., current) is allocated to processing circuit 44 by primary power functioning unit 3, this can be performed when controller 20 distributes activation signal to battery module 319 instructing battery module 319 to distribute operational power (e.g., current) to switch circuit 6 45 closing the circuitry of power-signal path 976 to allocate power (e.g., current) to or gate 1, and power (e.g., current) distributed to processing circuit 44 from secondary power functioning unit 39 is restricted at or gate 1 when power functioning controller 42 doesn't distributes power-signals (e.g., current) to switch circuit 5 37 opening the circuitry of power-signal path 975. For instance, during activation of intelligent automotive component 1 primary power functioning unit 3 is configured to distribute power (e.g., current) to processing circuit 44, in this case primary power functioning unit 3 power is high so the logic value input to or gate 1 is 1 and secondary power functioning unit 39 is low so the logic value input to or gate 1 is 0. Thus, in this circumstance, operation power is distributed to processing circuit 44 by primary power functioning unit 3.

Also, during activation of intelligent automotive component 1 power-signals (e.g., current) is allocated to high pressure pump power wire leads 5900 and lift pump power wire lead 5901 by secondary power functioning unit 39 via switch circuit 3 41, this can be performed when power functioning controller 42 distributes power-signals (e.g., current) to switch circuit 3 41 closing the circuitry of power-signal path 974 to allocate power-signals (e.g., current) to or gate 2, and power-signals (e.g., current) distributed to high pressure pump power wire lead 5900 and lift pump power wire lead 5901 from primary functioning unit 3 is restricted at or gate 2, this can be performed when power functioning controller 20 doesn't distributes power-signals (e.g., current) to switch circuit 2 31 opening the circuitry of power signal path 977.

For instance, during activation of intelligent automotive component 1 secondary power functioning unit 39 is configured to distribute power-signals to high pressure pump power wire lead 5900 and lift pump power wire lead 5901, in this case secondary power functioning unit 39 power is high so the logic value input to or gate 2 is 1 and primary power functioning unit 3 is low so the logic value input to or gate 2 is 0. Thus, in this circumstance, power-signals is distributed to high pressure pump power wire lead 5900 and lift pump power wire lead 5901 by secondary power functioning unit 39.

However, during deactivation of intelligent automotive component 1 operational power (e.g., current) is allocated to processing circuit 44 by charge circuit 18 via switch circuit 6 45, this can be performed when controller 20 of primary power functioning unit 3 distributes deactivation signal to battery module 319 of charge circuitry 18 instructing battery module 319 to distribute power-signals (e.g., current) to switch circuit 6 45 closing the circuitry of power-signal path 976 allocating power (e.g., current) to or gate 1, and power (e.g., current) distributed to processing circuit 44 from secondary functioning unit 39 is restricted at or gate 1 when power functioning controller 42 doesn't distributes power-signals (e.g., current) to switch circuit 537 opening the circuitry of power-signal path 975. For instance, during activation of intelligent automotive component 1 primary power functioning unit 3 is configured to distribute operational power to processing circuit 44, in this case primary power functioning unit 3 power is high so the logic value input to or gate 1 is 1 and secondary power functioning unit 39 is low so the logic value input to or gate 1 is 0. Thus, in this circumstance, operational power is distributed to processing circuit 44 by primary power functioning unit 3.

However, during deactivation of intelligent automotive component 1 power-signals (e.g., current) is restricted to high pressure pump power wire lead 5900 and lift pump power wire lead 5901 by secondary power functioning unit 39 via switch circuit 3 41, this can be performed when secondary functioning controller 39 doesn't distributes power-signals (e.g., current) to switch circuit 3 41 opening the circuitry of power signal path 974 via or gate 2, and power-signals (e.g., current) distributed to high pressure pump power wire lead 5900 and lift pump power wire lead 5901 from primary functioning unit 3 is restricted at or gate 2, this can be performed when power functioning controller 20 doesn't distributes power signals (e.g., current) to switch circuit 2 31 opening the circuitry of power signal path 977.

For instance, during deactivation of intelligent automotive component 1 battery module 319 of primary power functioning unit 3 is configured to allocate operational power to processing circuit 44, in this case primary power functioning unit 3 power is high so the logic value input to or gate 1 is 1 and secondary power functioning unit 39 is low so the logic value input to or gate 1 is 0.

For instance, when the ignition/push button is turned to the OFF or ACC position power signals (e.g., current) is supplied to primary and secondary power functioning unit 3 & 39 at an LOW state from vehicle power/signal-input 3200, and when the ignition/push button is turned to the START position power signal (e.g., current) is supplied to primary and secondary power functioning unit 3 & 39 at an HIGH state from vehicle power/signal-input 3200. In reference to the LOW and HIGH power states supplied to primary and secondary power functioning unit 3 & 39 one or more instructions stored in memory(s) 5 & 26 of controller 20 & 42 may be configured to determine the respective input power levels (e.g., current levels) input into primary and secondary power functioning unit 3 & 39 from vehicle power/signal-input 3200.

Thus, in this circumstance, operation power is distributed to processing circuit 44 by primary power functioning unit 39.

FIG. 6 illustrates the one or more power functioning units of power-link apparatus 64 in cooperation with intelligent automotive component (e.g., cfc unit) 1 of fuel cell vehicle for obtaining power signals (e.g., current) from vehicle power/signal-input 3200 to distribute power signals (e.g., current) to one or more components of power-link apparatus 64 and intelligent automotive component(s) (e.g., cfc unit) 1 in accordance with a preferred embodiment of the present invention.

In the light of the present invention, primary functioning unit 3 and secondary functioning unit 39 is configured to obtain power-signals (e.g., current) from an power-signal path 777 via terminal post 1500 obtaining power-signals from vehicle power/signal-input 3200. Further, secondary functioning unit 39 is configured to distribute power-signals (e.g., current) to high pressure pump power wire lead 5900 in response to wiring lead being communicable coupled to power-link apparatus 6400.

In reference to FIGS. 5A & 5B, power functioning circuitry of power-link apparatus 6400.

In accordance with the present invention comprises: primary power functioning unit 3 configured to distribute main power to processing circuitry 44 via obtaining power-signals (e.g., current) suppled by vehicle power/signal-input 3200 and distributing the obtained power-signals to processing circuitry 44 via or gate 1; secondary power functioning unit 39 is configured to distribute power-signals (e.g., current) to high pressure pump power wire lead 5900 and lift pump power wire lead 5901 via secondary power functioning unit 39 obtaining power-signals (e.g., current) from vehicle power/signal-input 3200.

Secondary power functioning unit 39 is also configured to distribute operation power (e.g., current) to processing circuit 44 via or gate 2. Secondary power functioning 39 unit may distribute any suitable voltage necessary according to specifications required to power the pump portion of high pressure pumps efficiently in response to the ignition/push button being turn to the START position. For instance, secondary power functioning unit 39 may provide anywhere in the range of 5.0V to 12V. Further, or gate 1 obtains operation power (e.g., current) from primary power functioning unit 3 and secondary power functioning unit 39 in cause to primary power functioning unit 3 and secondary power functioning unit 39 being respectively couple to or gate 1. And or gate 2 obtains operation power (e.g., current) from secondary power functioning unit 39 and primary functioning unit 39 in cause to primary power functioning unit 3 and secondary power functioning unit 39 being respectively coupled to or gate 2. Further, or gate 1 and or gate 2 distributes the operation power (e.g., current) on an single path due to different voltage levels and voltage levels increasing and rising at any giving interval varying on one or more operational phases.

Any suitable gate may be used to obtain and distribute operation power throughout power-link apparatus 6400 and intelligent automotive component 1.

Further, processing circuit 44 can be configured to obtain operational power (e.g., current) via or gate 1 and distribute an predetermine voltage to each respective electrical component according to the requirements to energize each respective electrical component of power-link apparatus 6400. Processing circuit 44 may comprise any suitable voltage regulators, resistor, transistors, capacitors, inverters, logic gates etc. configure to obtain input power (e.g., current) via or gate 1 and output an voltage to each respective electrical component (e.g., transceiver and processor(s) 6 etc.) of power-link apparatus 6400 at an predetermine range. For instance, 2.7V may be supplied to processor(s) 6 and 2.7V may be distributed to transceiver etc. Additionally, secondary power functioning unit 39 can be configured to distribute an operational power (e.g., current) to processing circuit 44 via or gate 1 in some instances.

In the preferred embodiment of the present invention, when power-link apparatus 6400 obtains an remote activation request signal (RARS) via control apparatus 1000 secondary power functioning unit 39 distributes power-signals (e.g., current) to pump power wire lead 5900. This is accomplished based upon processor(s) 6 distributing an first switch control signal (FSCS) to controller 42, upon controller 42 obtaining first switch control signal (FSCS) controller 42 is configured to generate and distribute an power-signal to switch circuit 3 41 to close the circuitry of power signal path 974 in order to allocate power-signal (e.g., current) to pump power wire lead 5900 and lift pump power wire lead 5901 via or gate 2.

Also, upon controller 42 obtaining first switch control signal (FSCS) controller 42 doesn't generate and distribute an power-signal to switch circuit 5 37 opening the circuitry of power-signal path 975 in order to restrict voltage power to processing circuit 44 via or gate 1.

In addition, when power-link apparatus 6400 obtains remote activation request signal (RARS) via control apparatus 1000 primary power functioning unit 3 distributes operational power (e.g., current) to processing circuit 44. This is accomplished based upon processor(s) 6 generating and distributing an second switch control signal (SSCS) to controller 20, upon controller 20 obtaining second switch control signal (SSCS) controller 20 is configured to generate and distribute an activation signal to battery module 319 instructing battery module to distribute operational power to switch circuit 6 45 to close the circuitry of power-signal path 976 in order to allocate operational power (e.g., current) to processing circuit 44 via or gate 1. Also, upon controller 20 obtaining second switch control signal (SSCS) controller 20 doesn't generate and distribute power-signal to switch circuit 2 31 restricting power-signals to pump power wire lead 5900 and lift pump power wire lead 5901 via or gate 2. During this operational stage operational main power is distributed to processing circuit 44 by primary power functioning unit 3 via or gate 1.

In some cases, during activation of intelligent automotive component 1, when battery of battery module 319 obtains an low battery capacity level battery module 319 can be configured to distribute an charge request signal to controller 20, in the event controller 20 can distribute power-signal to charge circuit 18 via controller 20 obtaining power-signals via vehicle power/signal input 3200 in order to charge battery of battery module 319 until battery module returns an high battery capacity level signal to controller 20.

However, when power-link apparatus 6400 obtains an remote deactivation request signal (RDRS) via control apparatus 1000 secondary power functioning unit 39 restricts power-signals (e.g., current) to pump power wire lead 5900 and lift pump power wire lead 5901. This is accomplished based upon processor(s) 6 distributing an first switch control signal (FSCS) to controller 42, upon controller 42 obtaining first switch control signal (FSCS) controller 42 doesn't generate and distribute an power-signal to switch circuit 3 41 opening the circuitry of power signal path 974 in order to restrict power (e.g., current) to pump power wire lead 5900 and lift pump power wire lead 5901 via or gate 2.

Also, upon controller 42 obtaining first switch control signal (FSCS) controller 42 doesn't generate and distribute a power-signal to switch circuit 5 37 to open the circuitry of the power signal path 975 in order to restrict power (e.g., current) to processing circuit 44 via or gate 1. Including, when power-link apparatus 64 obtains remote deactivation request signal (RDRS) via control apparatus 1000 primary power functioning unit 3 distributes operational power (e.g., current) to processing circuit 44. This is accomplished based upon processor(s) 6 generating and distributing an second switch control signal (SSCS) to controller 20, upon controller 20 obtaining second switch control signal (SSCS) controller 20 is configured to generate and distribute an deactivation signal to battery module 319 and battery module 319 is configured to distribute operational power to switch circuit 6 45 to close the circuitry of power-signal path 976 in order to allocate operational power (e.g., current) to processing circuit 44 via or gate 1. Also, upon controller 20 obtaining second switch control signal (SSCS) controller 20 doesn't generate and distribute an power-signal to switch circuit 2 31 opening the circuitry of power-signal path 977 in order to restrict power-signals to pump power wire lead 5900 and lift pump power wire lead 5901 via or gate 2. Also, during this operational stage operation main power is distributed to processing circuit 44 by primary power functioning unit 3 via or gate 1.

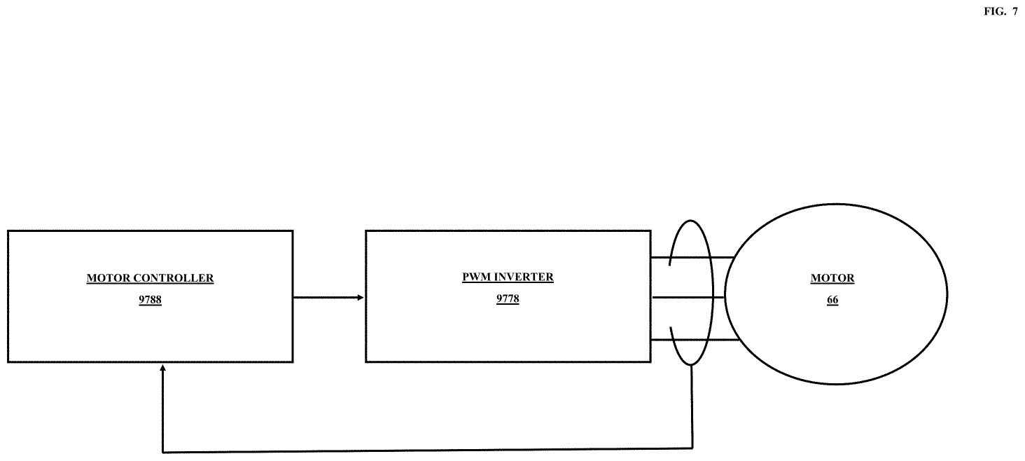

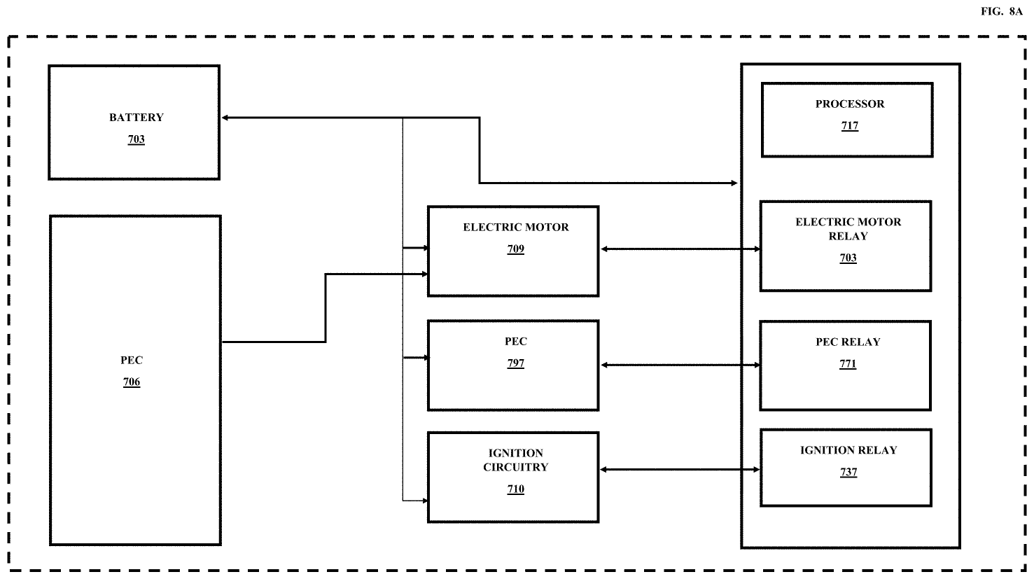

FIG. 7 is an block diagram of motor drive system for an electric vehicle according an embodiment of the present invention. Motor drive system consist of electric motor 66 (e.g., intelligent automotive component) having an permanent magnet on an rotor and an armature winding on an stator. PWM (e.g., pulse width modulation) inverter 9778 that, according to the rotor position of motor 66, supplies three-phase alternating-current voltages, consisting of U-phase, V-phase, and W-phase voltages, to motor 66. Motor controller 9788 is configured to based on current distributed to motor 66 estimates the rotor position of motor 66, and feeds PWM inverter 9778 with a signal for rotating motor 66 at an desired rotation speed. Motor controller 9788 can also be configured to transforms the battery's direct current into alternating current and regulates the energy flow from the battery. Motor controller 9788 can also reverse motor 66 rotation so the vehicle can go in reverse, and convert motor 66 to an generator so that the kinetic energy of motion can be used to recharge the battery when the brake is applied.

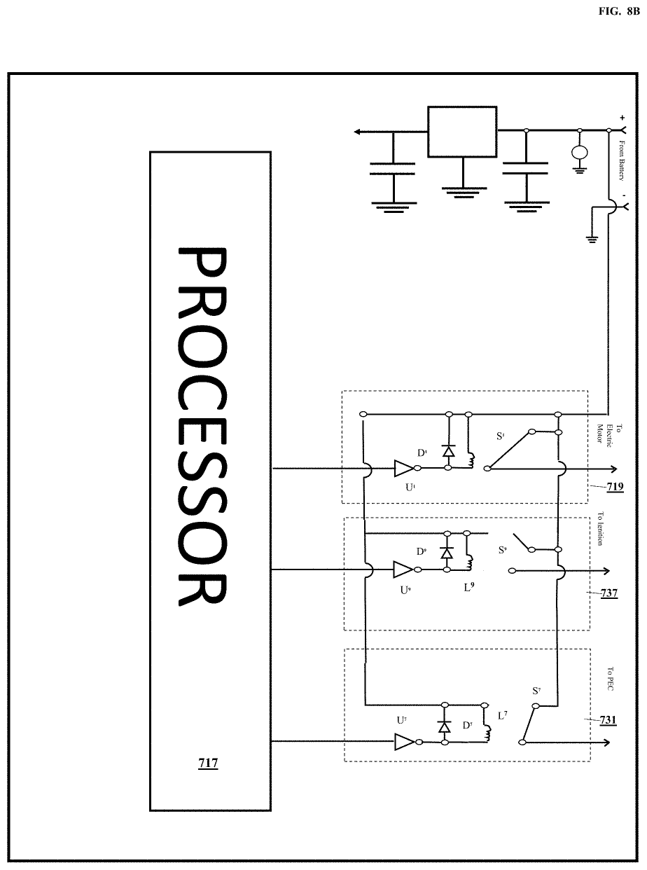

FIGS. 8A & 8B shows a block diagram of the preferred embodiment of an fuse box and relay box of the electric vehicle system.

Vehicle includes battery 703, power electronics controller (PEC) 706, electric motor circuit (IAC) 709, PEC circuit (IAC) 797 and ignition circuit 710. Fuel box 721 can include processor 717, electric motor relay 719, PEC relay 771 and ignition circuit relay 737. In addition, processor 717 can be coupled to electric motor relay 719, PEC relay 731 and ignition circuit relay 737.

In such implementation battery 703 can be coupled to electric motor (IAC) 709, PEC 706 and ignition circuit 710. Battery 703 can be a standard 12V or 24V vehicle battery, auxiliary battery or traction battery pack. Power electronics controller (PEC) 706 can be coupled to electric motor (IAC) 709 and ignition circuit 710.

Further, power electronics controller (PEC) 706 can be configure to manage the flow of electrical energy delivered by the traction battery, control the speed of the electric traction motor and torque it produces.

Electric motor relay 719 can comprise a processor controller and relay system controlled by processor 717, and can be coupled to a input of electric motor (IAC) 709. Electric motor relay 719 can be configured connect electric motor (IAC) 709 to traction battery pack of electric vehicle via an high power gauge or terminal wire.

And on, electric motor relay 719 is preferably configured to allow an power-signal to be sent to electric motor (IAC) 709 perpetually to keep currents supplied to power-link apparatus when the ignition/push button is at the OFF, RUN, START position, and to start the vehicle when the ignition is at the START position. Electric motor relay 719 can include a operational amplifier U¹ connected to a diode and inductor L¹, with a switch connected thereto, such that inductor L¹ is configured to control a state of switch S¹ to keep at a closed position to perpetually allocate power-signals (e.g., current) to electric motor (IAC) 709. For example, on conventional electric vehicles (EV) and hybrid vehicles inductor L¹ is configured to control a state of switch S¹ of electric motor relays 719 to a open position restricting power-signals (e.g., current) to electric motor when the ignition is turned to the OFF position, and inductor L¹ is configured to control a state of switch S¹ to the close position allocating power to the electric motor when the ignition is turned back to the ACC, RUN or SART position. Whereby as described in the current invention inductor L¹ is configured to control a state of switch S¹ to the close position at all times weather the position of the ignition/push-button is at the OFF, ACC, RUN, START position in order to allocate power-signals (e.g., current) to the power-link apparatus in order to power the power-link apparatus, and to allocate an higher power to energize the coils of electric motor (IAC) 709 when the ignition is turned to the START position or when the ignition push button has been pressed.

However, PCE relay 771 can comprise processor 717 and relay system to couple an terminal of PEC 706 to the positive terminal of battery 703 or to the ground circuit of the vehicle. Ignition circuit relay 737 can comprise processor 717 and a relay system to activate ignition circuit 710. Ignition circuit relay 737 can include an operational amplifier U⁹ connected to diode D⁹ and inductor L⁹, with switch S⁹ connected thereto, such that inductor L⁹ can control whether or not switch S⁹ is opened or closed.

Further, PEC relay 771 is also preferably configured to allow an power-signal to be sent to PEC 706 to perpetually keep currents supplied to power-link apparatus when the ignition/push button is at the OFF, RUN, START position. PEC relay 771 can include an operational amplifier connected to diode D⁷ and an inductor L⁷, with switch S⁷ connected thereto, such that inductor L⁷ is configured to control a state of switch S⁷ to keep at a closed position to perpetually allocate power-signals to PEC 797. For example, on electric vehicle (EV) and hybrid vehicles inductor L⁷ is configured to control a state of switch S⁷ of PEC relays to a open position restricting power-signals (e.g., current) to the PEC when the ignition/push button is turned to the OFF position, and inductor L⁷ is configured to control a state of switch S⁷ to the close position allocating power-signals to PEC when the ignition/push button is turned back to the ACC, RUN or START position. Whereby as described in the current invention inductor L⁷ is configured to control a state of switch S⁷ to the close position at all times weather the position of the ignition/push button is at the OFF, ACC, RUN, START position.

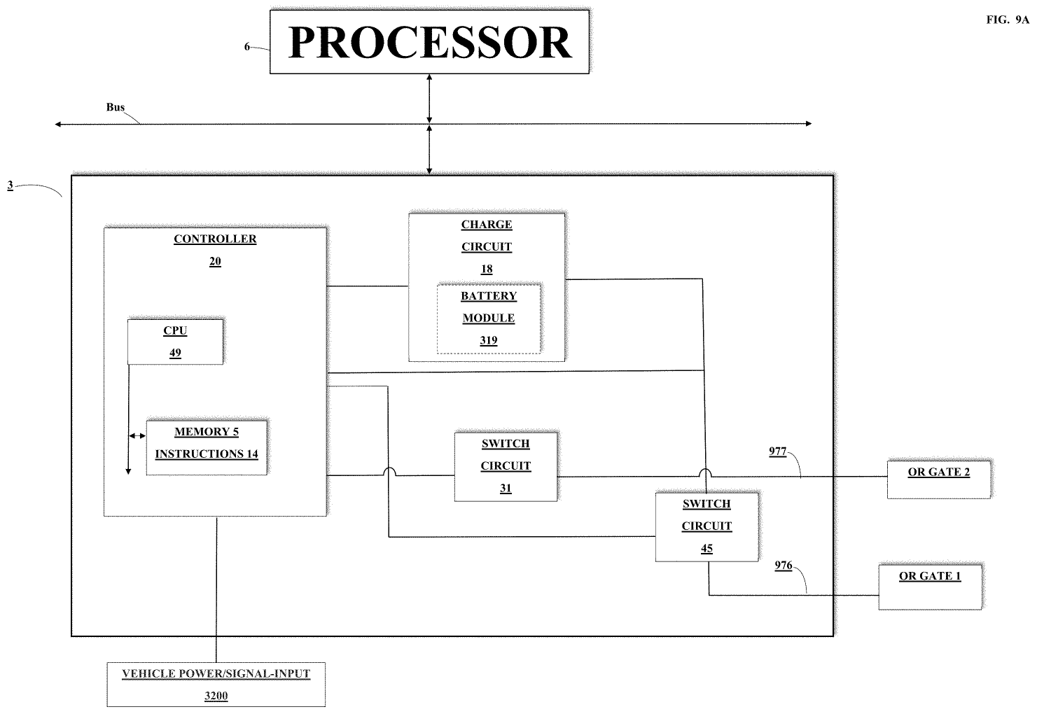

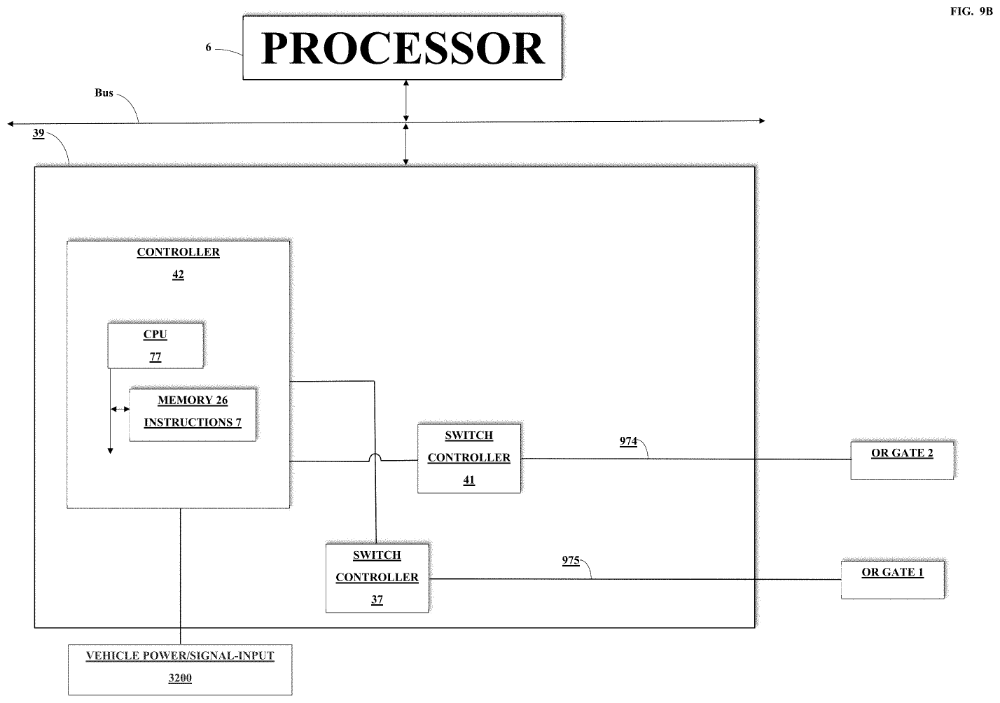

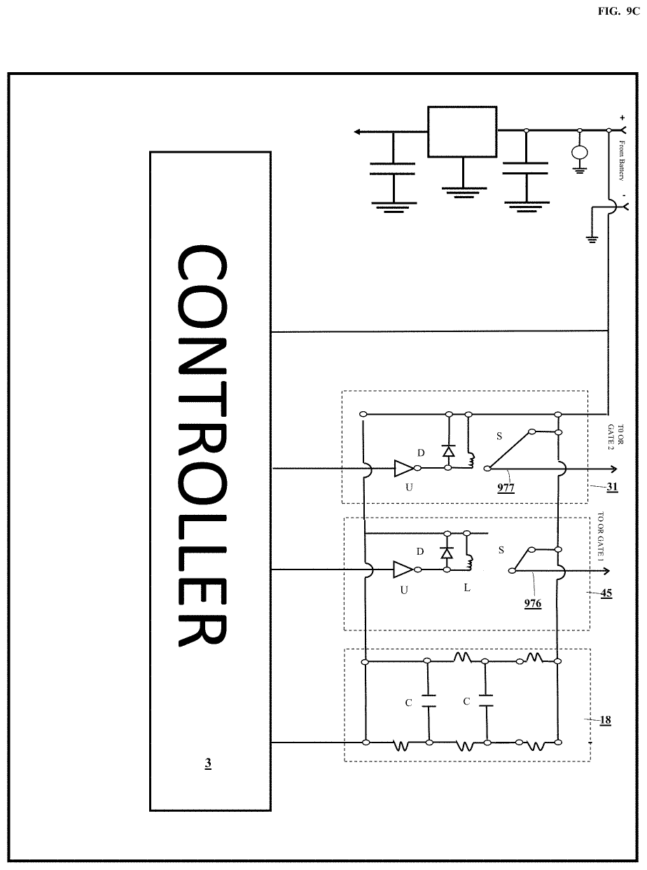

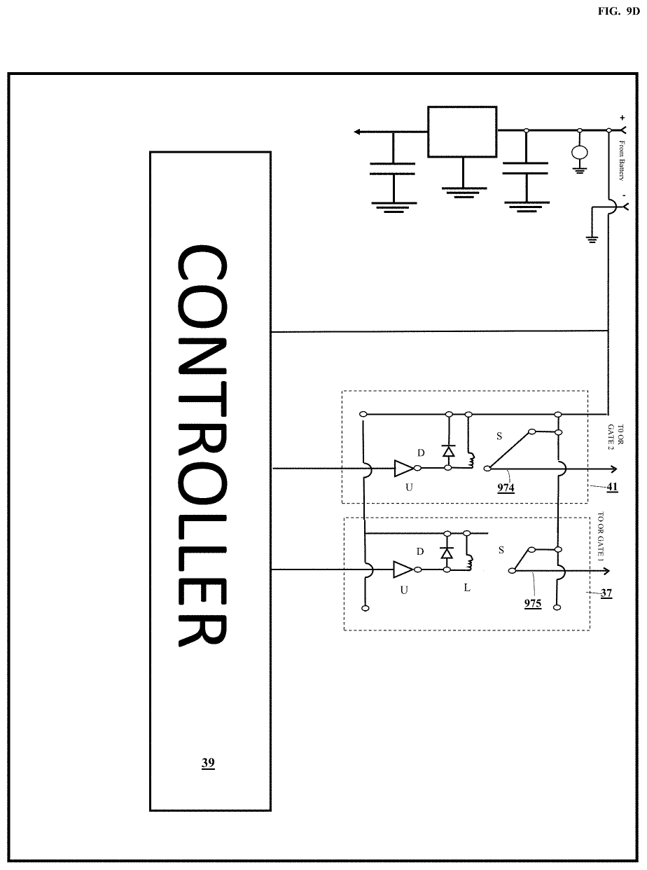

Accordingly FIGS. 9A & 9B is an illustration of the power supply circuit of power-link apparatus 64 for electric motor of electric power steering gear. Primary power functioning unit 3 is configured to distribute operation power (e.g., current) to processing circuit 44 via or gate 1. Secondary power functioning unit 39 is configured to distribute power-signals (e.g., current) to head coil end (e.g., U-phase head coil end, V-phase head coil end and W-phase head coil end) of stator coil 2100 to energize the stator coils to turn the rotor of electric motor via or gate 2 in response to processor(s) 6 obtaining remote activation request signal and the user of the vehicle turning the ignition/push button to the start position, and can also restrict power-signals (e.g., current) to head coil end (e.g., U-phase head coil end, V-phase head coil end and W-phase head coil end) 2199 of stator coil 6600 in response to processor(s) 6 obtaining remote deactivation request signal via control apparatus 1000.

Power-link apparatus 64 comprises bus 1001 for connecting primary power functioning unit 3 and secondary power functioning unit 39 to processor(s) 6 and other electrical components for delivering one or more communication signals (e.g., switch control signals, messages, data or instructions) between the components. Primary power functioning unit 3 comprises controller 20, switch circuit 2 31, switch circuit 6 45 and charge circuitry 18.

Controller 20 is configured to control one or more task operations of primary power functioning unit 3 such as controlling the overall aspect of allocating and restricting of power of switch circuits.

Controller 20 can be configured to stabilize input power (e.g., current) supplied by input/output terminals 7946 via PWM inverter 9778.

Primary power functioning unit 3 comprises switch circuit 2 31 having duties of switching between opening and closing the circuitry of power-signal path 977 in order to allocate or restrict operational power (e.g., current) to processing circuit 44 via or gate 1, and switch circuit 6 45 can having duties of switching between opening circuitry of power-signal path 976 to allocate or restrict voltage power-signals (e.g., current) to head coil end (e.g., U-phase head coil end, V-phase head coil end and W-phase head coil end) 6601 of stator coil via or gate 2.

Switch circuitry 6 45 and switch circuit 2 31 can be a switching circuitry having an operational amplifier U connected to a diode D and an inductor L, with at least one switch S connected thereto, such that inductor L can control whether or not switch is opened or closed base upon a change of resistance of power-signals (e.g., current) suppled to switch circuitry 6 45 and switch circuit 2 31 under the control of controller 20. For instance, inductor L of switch circuitry 6 45 and switch circuit 2 31 can be configured control the closing of switch S in order to allocate power-signals (e.g., current) based upon controller 20 distributing power-signals (e.g., current) to switch circuitry 6 45 and switch circuit 2 31 and the power-signal (e.g., current) energizing the coils of inductor L attracting the switch S to close the circuit of respective power-signal paths respectively. And the inductor L of switch circuitry 6 45 and switch circuit 2 31 can be configured control the opening of switch S to restrict power-signals (e.g., current) based upon controller 20 not distributing power-signals (e.g., current) to switch circuitry 6 45 and switch circuit 2 31 this causes the coils of inductors L to not be energized and retracting the switch S to open the circuit of respective power-signal paths respectively FIG. 9C.

Primary power functioning unit 3 comprises charge circuit 18 consisting of an battery controller and memory's for distributing operational power (e.g., current) to processing circuit 44 via power-signal path 976 via or gate 1 weather the vehicle is on or off.

Controller 20 comprises Central Processing Unit (CPU) 49 that comprises one or more cores. Controller 20 comprises Random Only Memory (ROM) 50 for storing one or more control programs to control the one or more switch circuits (e.g., distributing power-signals (e.g., current)) in response to obtaining an switch control signal via processor(s) 6. Controller 20 also comprises Random Access Memory (RAM) 51 for storing signals and data obtained by processor(s) 6, or for use as an memory space for an operation preformed by primary power functioning unit 3. CPU 49, ROM 50 and RAM 51 may be interconnected via an internal bus.

Secondary power functioning unit 39 comprises controller 42, switch circuit 3 41 and switch circuit 5 37.

Secondary power functioning unit 39 comprises switch circuit 3 41 having duties of switching between opening or closing the circuitry of power signal path 974 in order to allocate or restrict power-signals (e.g., current) to head coil end (e.g., U-phase head coil end, V-phase head coil end and W-phase head coil end) 2199 of stator coil 6600 via or gate 2 in response to processor 6 obtaining a remote activation or deactivation request signal via control apparatus 1000.

Switch circuit 5 37 can have duties of switching between opening or closing the circuitry of power signal path 975 on order to allocate or restrict operational power (e.g., current) to processing circuit 44 or gate 1.

Switch circuitry 3 41 and switch circuit 5 37 can be a switching circuitry having an operational Amplifier U connected to a diode D and an inductor L, with at least one switch S connected thereto, such that inductor L can control whether or not switch S is opened or closed. Controller 42 can be configured to control one or more task operations of secondary power functioning unit 39 such as controlling the switching of the switch circuit respectively FIG. 9D.

Controller 42 also comprises Central Processing Unit (CPU) 52 that comprises one or more cores. Random Only Memory (ROM) 53 can store one or more control programs to control the one or more switch circuits, in response to obtaining a switch control signal via processor(s) 6. Random Access Memory (RAM) 54 can store data and instructions to execute a task upon obtaining a remote activation or deactivation signal, or for use as an memory space for an operation preformed by secondary power functioning unit 39. CPU 52, ROM 53 and RAM 54 may be interconnected via an internal bus.

As illustrated, primary power functioning unit 3 and secondary power functioning unit 39 is coupled to processor(s) 6 via bus 1001 and whereby can be configured to obtain instruction and signals to execute one or more task.

The OR gates used in the present invention is an digital logic gate that implements logical disjunction it behaves according to the truth table; A HIGH output (1) results if one or both of the inputs to the gate are HIGH (1). If neither input is high, a LOW output (0) results. In another sense, the function of OR effectively finds the maximum between two binary digits, just as the complementary and function finds the maximum.

According to the present invention, during activation of intelligent automotive component 1 power-signals (e.g., current) is allocated to processing circuit 44 by battery module 319 of primary power functioning unit 3, this can be performed when controller 20 distributes activation signal to battery module 319 instructing battery module 319 to distribute power-signals (e.g., current) to switch circuit 6 45 closing the circuitry of power signal path 976 allocating power-signals (e.g., current) to or gate 1, and power (e.g., current) distributed to processing circuit 44 from secondary power functioning unit 39 is restricted at or gate 1, this can be performed when controller 42 doesn't distributes power-signals (e.g., current) to switch circuit 5 37 opening the circuitry of power-signal path 975. For instance, during activation of intelligent automotive component 1 primary power functioning unit 3 is configured to distribute power-signals (e.g., current) to processing circuit 44, in this case primary power functioning unit 3 power is high so the logic value input to or gate 1 is 1 and secondary power functioning unit 39 is low so the logic value input to or gate 1 is 0. Thus, in this circumstance, operation power is distributed to processing circuit 44 by primary power functioning unit 3.

Also, during activation of intelligent automotive component 1 power-signal (e.g., current) is allocated to head coil end (e.g., U-phase head coil end, V-phase head coil end and W-phase head coil end) 6601 of stator coil by secondary power functioning unit 39 via switch circuit 3 41, this can be performed when controller 42 distributes power signals (e.g., current) to switch circuit 3 41 closing the circuitry of power signal path 974 to allocate power signals (e.g., current) to or gate 2, and power (e.g., current) distributed to head coil end (e.g., U-phase head coil end, V-phase head coil end and W-phase head coil end) 2199 of stator coil 6600 from primary functioning unit 3 is restricted at or gate 2, this can be performed when power functioning controller 20 doesn't distributes power-signals (e.g., current) to switch circuit 2 31 opening the circuitry of power signal path 977.

For instance, during activation of intelligent automotive component 1 secondary power functioning unit 39 is configured to distribute power-signals to head coil end (e.g., U-phase head coil end, V-phase head coil end and W-phase head coil end) 2199 of stator coil 6600, in this case secondary power functioning unit 39 power is high so the logic value input to or gate 2 is 1 and primary power functioning unit 3 is low so the logic value input to or gate 2 is 0. Thus, in this circumstance, operation power is distributed to head coil end (e.g., U-phase head coil end, V-phase head coil end and W-phase head coil end) 6601 of stator coil by secondary power functioning unit 39.

However, during deactivation of intelligent automotive component 1 power-signals (e.g., current) is allocated to processing circuit 44 by battery module 319 of primary power functioning unit 3 via switch circuit 6 45, this can be performed when controller 20 distributes deactivation signal to battery module 319 instructing battery module 319 to distribute operational power (e.g., current) to switch circuit 6 45 closing the circuitry of power-signal path 976 to allocate power-signals (e.g., current) to or gate 1, and power (e.g., current) distributed to processing circuit 44 from secondary functioning unit 39 is restricted at or gate 1, this can be performed when controller 42 doesn't distributes power-signals (e.g., current) to switch circuit 5 37 opening the circuitry of power-signal path 975. For instance, during activation of intelligent automotive component 1 primary power functioning unit 3 is configured to distribute power to processing circuit 44, in this case primary power functioning unit 3 power is high so the logic value input to or gate 1 is 1 and secondary power functioning unit 39 is low so the logic value input to or gate 1 is 0. Thus, in this circumstance, operation power is distributed to processing circuit 44 by primary power functioning unit 3.

However, during deactivation of intelligent automotive component 1 power-signals (e.g., current) is restricted to head coil end (e.g., U-phase head coil end, V-phase head coil end and W-phase head coil end) 2199 of stator coil 6600 by secondary power functioning unit 39 via switch circuit 3 41, this can be performed when secondary functioning controller 39 doesn't distributes power-signals (e.g., current) to switch circuit 3 41 opening the circuitry of power signal path 974 via or gate 2, and power-signals (e.g., current) distributed to head coil end (e.g., U-phase head coil end, V-phase head coil end and W-phase head coil end) 2199 of stator coil 6600 from primary functioning unit 3 is restricted at or gate 2, this can be performed when controller 20 doesn't distributes power signals (e.g., current) to switch circuit 2 31 opening the circuitry of power signal path 977.

In some cases, during activation of intelligent automotive component 1, when battery of battery module 319 obtains an low battery capacity level battery module 319 can be configured to distribute an charge request signal to controller 20, in the event controller 20 can distribute power-signal to charge circuit 18 via controller 20 obtaining power-signals via vehicle power/signal input 3200 in order to charge battery of battery module 319 until battery module returns an high battery capacity level signal to controller 20.

For instance, during deactivation of intelligent automotive component 1 primary power functioning unit 3 is configured to allocate power to processing circuit 44, in this case primary power functioning unit 3 power is high so the logic value input to or gate 1 is 1 and secondary power functioning unit 39 is low so the logic value input to or gate 1 is 0.

For instance, when the ignition/push button is turned to the OFF or ACC position power-signals (e.g., current) is supplied to primary and secondary power functioning unit 3 & 39 at an LOW state from vehicle power/signal-input 3200 (e.g., high power gage, terminal wire or etc.), and when the ignition/push button is turned to the START position power (e.g., current) is supplied to primary and secondary power functioning unit 3 & 39 at an HIGH state from vehicle power/signal-input 3200 (e.g., high power gage, terminal wire or etc.). In reference to the LOW and HIGH power states supplied to primary and secondary power functioning unit 3 & 39 one or more instructions stored in memory(s) 5 & 26 of controller 20 & 42 may be configured to determine the respective input power levels (e.g., current levels) input into primary and secondary power functioning unit 3 & 39 from vehicle power/signal-input 3200 (e.g., high power gage, terminal wire or etc.).

Thus, in this circumstance, operation power is distributed to processing circuit 44 by primary power functioning unit 39.

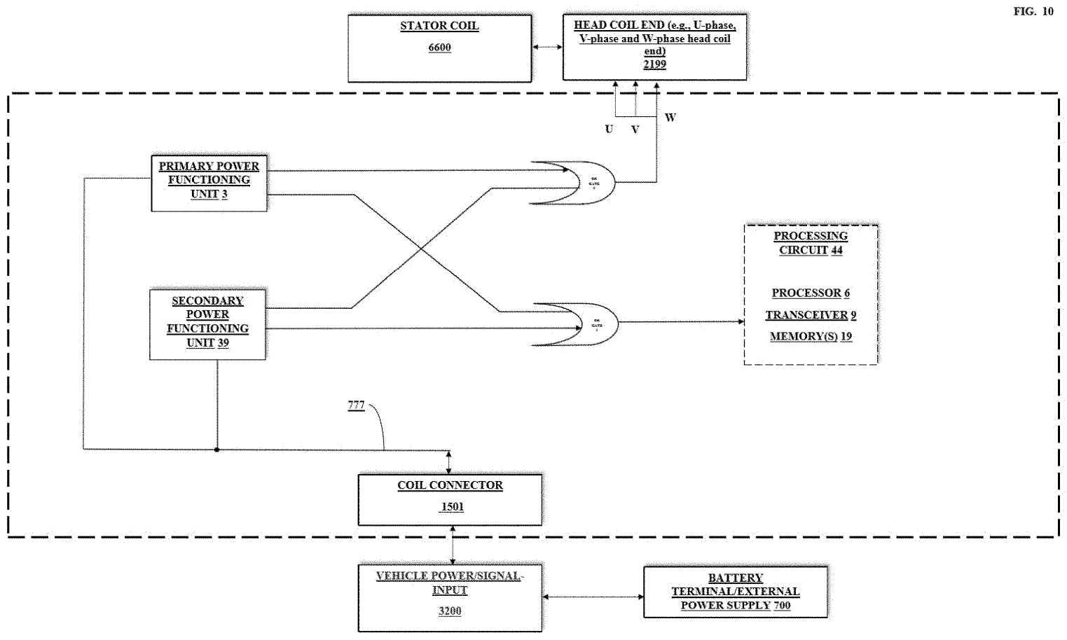

FIG. 10 illustrates the one or more power functioning units of power-link apparatus 6400 in cooperation with intelligent automotive component 1 (e.g., electric motor) of electric power steering gear for obtaining power-signals (e.g., current) from vehicle power/signal-input 3200 (e.g., high power gage, terminal wire or etc.) to distribute power signals (e.g., current) to one or more components of power-link apparatus 6400 and intelligent automotive component(s) 1 in accordance with a preferred embodiment of the present invention.

In the light of the present invention, primary functioning unit 3 and secondary functioning unit 39 is configured to obtain power-signals (e.g., current) from power-signal path 777 of head coil end (e.g., U-phase head coil end, V-phase head coil end and W-phase head coil end) 2199 of stator coil 6600 via coil connector 7714 obtaining power from vehicle power/signal-input 3200.

Further, secondary functioning unit 39 is configured to distribute power-signals (e.g., current) to stator coils 6600 in response to head coil end (e.g., U-phase head coil end, V-phase head coil end and W-phase head coil end) 2199 of stator coil 6600 being communicable coupled to power-link apparatus 6400.

In reference to FIGS. 9A & 9B, power functioning circuitry of power-link apparatus 6400 of electric motor of electric power steering gear.

In accordance with the present invention comprises: primary power functioning unit 3 is configured to distribute main power to operate processing circuitry 44 via obtaining power (e.g., current) suppled by vehicle power/signal-input 3200 and distributing the obtained power to processing circuitry 44 via or gate 1; secondary power functioning unit 39 is configured to distribute power-signals (e.g., current) to head coil end (e.g., U-phase head coil end, V-phase head coil end and W-phase head coil end) 2199 of stator coil 6600 via secondary power functioning unit 39 obtaining power-signals (e.g., current) from vehicle power/signal-input 3200. Secondary power functioning unit 39 is also configured to distribute operation power (e.g., current) to processing circuit 44 via or gate 2. Secondary power functioning 39 unit may distribute any suitable voltage necessary according to specifications required to energize the stator coils 6600 to rotate the rotors efficiently in response to the ignition/push buttons being turn to the START position. For instance, secondary power functioning unit 39 may provide anywhere in the range of 400V or more. Further, or gate 1 obtains operation power-signals (e.g., current) from primary power functioning unit 3 and secondary power functioning unit 39 in cause to primary power functioning unit 3 and secondary power functioning unit 39 being respectively couple to or gate 1. And or gate 2 obtains operation power (e.g., current) from secondary power functioning unit 39 and primary functioning unit 39 in cause to primary power functioning unit 3 and secondary power functioning unit 39 being respectively coupled to or gate 2. Further, or gate 1 and or gate 2 distributes the operation power (e.g., current) on an single path due to different voltage levels and voltage levels increasing and rising at any giving interval varying on one or more operational phases.

Any suitable gate may be used to obtain and distribute operation power throughout power-link apparatus 6400 and intelligent automotive component 1.

Further, processing circuit 44 can be configured to obtain operational power (e.g., current) via or gate 1 and distribute an predetermine voltage to each respective electrical component according to the requirements to energize each respective electrical component of power-link apparatus 6400. Processing circuit 44 may comprise any suitable voltage regulators, resistor, transistors, capacitors, inverters, logic gates etc. configure to obtain input power-signals (e.g., current) via or gate 1 and output an voltage to each respective electrical component (e.g., transceiver and processor(s) 6 etc.) of power-link apparatus 6400 at an predetermine range. For instance, 2.7V may be supplied to processor(s) 6 and 2.7V may be distributed to transceiver etc.

Additionally, secondary power functioning unit 39 can be configured to distribute an operational power (e.g., current) to processing circuit 44 via or gate 1 in some instances.

In the preferred embodiment of the present invention, when power-link apparatus 6400 obtains an remote activation request signal (RARS) via control apparatus 1000 secondary power functioning unit 39 distributes power-signals (e.g., current) to head coil end (e.g., U-phase head coil end, V-phase head coil end and W-phase head coil end) 2190 of stator coil 6600. This is accomplished based upon processor(s) 6 distributing an first switch control signal (FSCS) to controller 42, upon controller 42 obtaining first switch control signal (FSCS) controller 42 is configured to generate and distribute an activation signal to battery module 319 to instruct battery module 319 to distribute power-signal to switch circuit 3 41 to close the circuitry of power-signal path 974 in order to allocate power-signals (e.g., current) to head coil end (e.g., U-phase head coil end, V-phase head coil end and W-phase head coil end) 2199 of stator coil 6600 via or gate 2. Also, upon controller 42 obtaining first switch control signal (FSCS) controller 42 doesn't generate and distribute an power-signal to switch circuit 5 37 opening the circuitry of power-signal path 975 in order to restrict voltage power to processing circuit 44 via or gate 1.

In addition, when power-link apparatus 6400 obtains remote activation request signal (RARS) via control apparatus 1000 primary power functioning unit 3 distributes operational power (e.g., current) to processing circuit 44. This is accomplished based upon processor(s) 6 generating and distributing an second switch control signal (SSCS) to controller 20, upon controller 20 obtaining second switch control signal (SSCS) controller 20 is configured to generate and distribute an power-signal to switch circuit 6 45 to close the circuitry of power-signal path 976 in order to allocate operational power (e.g., current) to processing circuit 44 via or gate 1. Also, upon controller 20 obtaining second switch control signal (SSCS) controller 20 doesn't generate and distribute an power-signal to switch circuit 2 31 restricting power-signals to head coil end (e.g., U-phase head coil end, V-phase head coil end and W-phase head coil end) 2199 of stator coil 6600 via or gate 2. During this operational stage operational main power is distributed to processing circuit 44 by primary power functioning unit 3 via or gate 1.

However, when power-link apparatus 6400 obtains an remote deactivation request signal (RDRS) via control apparatus 1000 secondary power functioning unit 39 restricts voltage power-signals (e.g., current) to head coil end (e.g., U-phase head coil end, V-phase head coil end and W-phase head coil end) 2199 of stator coil 6600. This is accomplished based upon processor(s) 6 distributing an first switch control signal (FSCS) to controller 42, upon controller 42 obtaining first switch control signal (FSCS) controller 42 doesn't generate and distribute a power-signal to switch circuit 3 41 opening the circuitry of power signal path 974 in order to restrict power-signals (e.g., current) to coil terminal 5900 via or gate 2.

Also, upon power functioning controller 42 obtaining first switch control signal (FSCS) controller 42 doesn't generate and distribute an power-signal to switch circuit 5 37 to open the circuitry of the power-signal path 975 in order to restrict operational power (e.g., current) to processing circuit 44 via or gate 1.

Including, when power-link apparatus 6400 obtains remote deactivation request signal (RDRS) via control apparatus 1000 primary power functioning unit 3 distributes operational power (e.g., current) to processing circuit 44. This is accomplished based upon processor(s) 6 generating and distributing an second switch control signal (SSCS) to controller 20, upon controller 20 obtaining second switch control signal (SSCS) controller 20 is configured to generate and distribute an deactivation signal to battery module 319 instructing battery module 319 to distribute an power-signal to switch circuit 6 45 to close the circuitry of power-signal path 976 in order to allocate operational power (e.g., current) to processing circuit 44 via or gate 1. Also, upon controller 20 obtaining second switch control signal (SSCS) controller 20 doesn't generate and distribute an power-signal to switch circuit 2 31 opening the circuitry of the power-signal path 977 in order to restrict power-signals to head coil end (e.g., U-phase head coil end, V-phase head coil end and W-phase head coil end) 2199 of stator coil 6600 via or gate 2. Also, during this operational stage operation main power is distributed to processing circuit 44 by primary power functioning unit 3 via or gate 1.

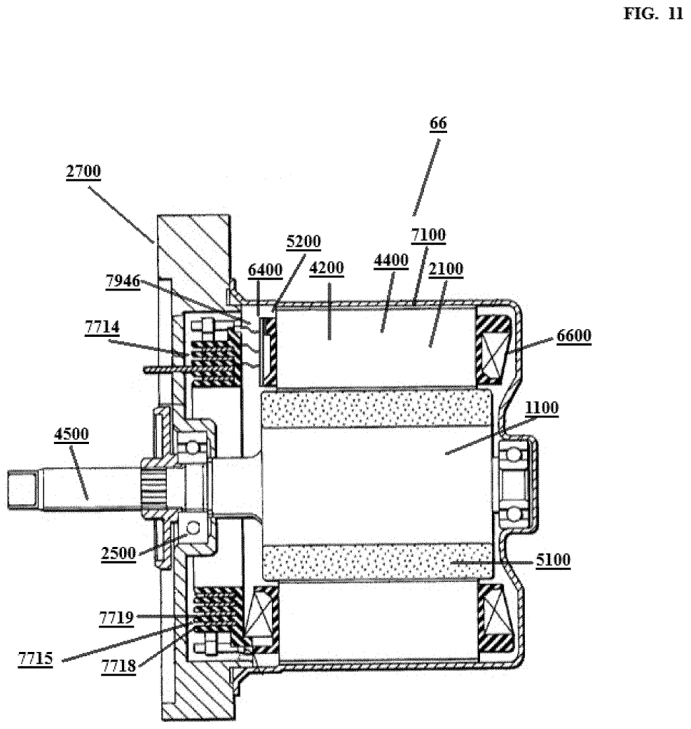

FIG. 11 illustrates an cross-sectional view of electric power steering gear having an intelligent automotive component for the electric vehicle according to the present invention.

Electric power steering gear includes motor 66 (e.g., intelligent automotive component) consisting of an stator 2100 press fit within the inner circumference of frame 4400, and a rotor 1100 respectively disposed within an internal bore of stator 2100. Rotor 1100 consist of magnet 5100 bonded to shaft 4500 reinforced and freely rotatable by bearing 2500 provided in housing 2700 and an bearing 2500 provided between an opposing end of shaft 4500 and frame 4400.

Stator 2100 includes stator core 4200, coil bobbin 5200 coupled with an insulation stator core 4200, stator coil 6600 is wound around coil bobbin 5200. Stator coil 6600 is coupled to power-link apparatus 6400 via an head coil end (e.g., U-phase head coil end, V-phase head coil end and W-phase head coil end) of stator coil 6600.

Power-link apparatus 64 consist of input/output terminals (e.g., U-phase terminal, V-phase terminal and W-phase terminal) 7946 communicable coupled to coil connector 7714 disposed on the front surface of stator 2100 for obtaining and distributing power-signal (e.g., currents) to and from power-link apparatus 64 and PWM (e.g., pulse width modulation) inverter via PWM (e.g., pulse width modulation) inverter being communicable coupled to electrical connector 7714 via 3-phase cables (U phase, V-phase, W-phase).

Input/output terminals 7946 of power-link apparatus 6400 is also configured to distribute power-signals (e.g., current) to one or more components of power-link apparatus 6400 circuitry, and to distribute power-signals (e.g., current) to stator coils 6600 via head coil end (e.g., U-phase head coil end, V-phase head coil end and W-phase head coil end) of stator coil 6600 upon obtaining an remote activation request signal via control apparatus to provide torque to rotate the vehicle tires thereof.

Input/output terminals 7946 of power-link apparatus 6400 is also configured to restrict power-signals (e.g., current) to stator coils 6600 via head coil end (e.g., U-phase head coil end, V-phase head coil end and W-phase head coil end) of stator coil 6600 upon processor of power-link apparatus 6400 obtaining an remote deactivation request signal via control apparatus to restrict power-signals so that an torque cant be provided to rotate the vehicle tires thereof. Coil connector 7714 can comprise of an split phase conductive member 7719 or in-phase conductive member 7718 in a groove provided in holder 7715. Power-signals (e.g., current) can be distributed to power-link apparatus 6400 via PWM via an connection terminal of split phase conductive member 7719.

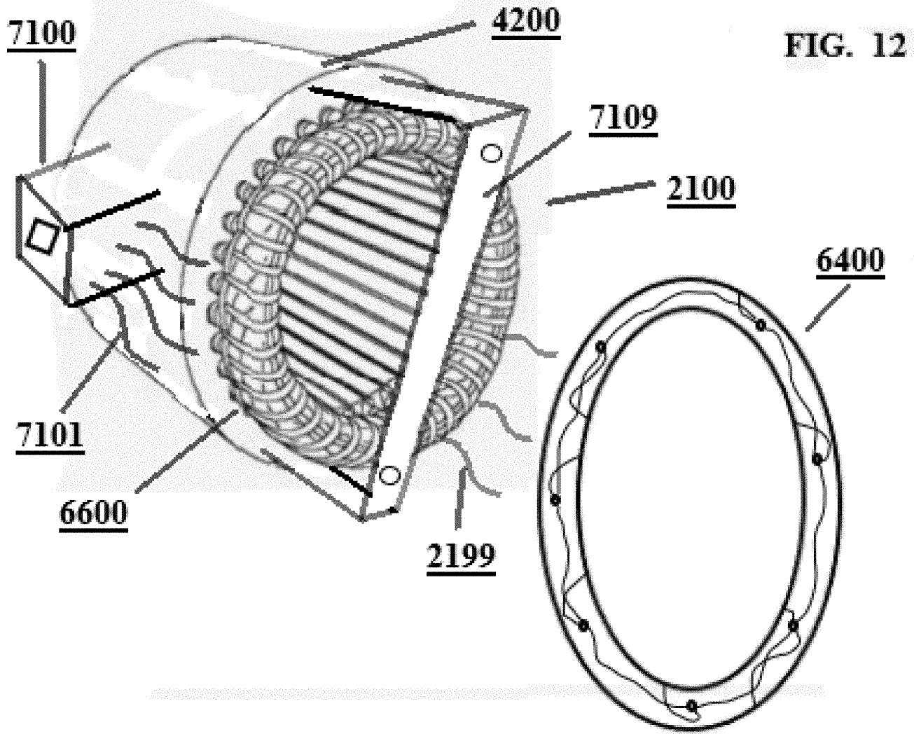

FIG. 12 illustrates an front view of stator 2100. Stator 2100 consist of an plurality of stator coils 6600 within the internal bore of stator iron core 4200. Specifically, stator coil 2100 consist of an extending head coil end (e.g., U-phase head coil end, V-phase head coil end and W-phase head coil end) 2199 about the axial direction from obverse opening of stator iron core 2110. Head coil end (e.g., U-phase head coil end, V-phase head coil end and W-phase head coil end) 2199 is coupled to an power-signal path, conductor or data/power bus of ring-shaped power-link apparatus 6400 for obtaining and distributing power-signals (e.g., currents) to and from stator coils 6600 and power-link apparatus 6400. Each head coil end (e.g., U-phase head coil end, V-phase head coil end and W-phase head coil end) 2199 of stator coils 6600 can be coupled to an single power signal path or respective power signal paths of power-link apparatus 6400 for obtaining and distributing power-signals (e.g., currents) to and from stator coils 6600 and power-link apparatus 6400. An rim area of stator iron core 4200 can consist of an member 7109 extending from rim area of stator iron core 4200 for communicable coupling power-link apparatus 6400 to stator iron core 4200 via screws or an adhesive, in other instances power-link apparatus 6400 can assemble directly onto stator coils 6600 without member 7109.

Stator iron core 4200 also consist of cooling apparatus 7100 provided on an side area of thereof, cooling apparatus 7100 can consist of one or more coolant lines 7107, one or more fastening elements for coupling cooling apparatus 7100 to stator iron core 4200 and one or more thermal insulation elements.

Member 7109 consist of one or more slot for allocating the head coil end (e.g., U-phase head coil end, V-phase head coil end and W-phase head coil end) 2199 of stator coils 6600 and coolant lines 7107 to extend through the member to couple to the power-link apparatus 6400. Coolant line 7107 can be divided by an plurality of supporting walls constituting an plurality of coolant channels. Coolant line 7107 can be made of an light weight material such as aluminum or the likes. The one or more fasting elements can be made of an elastic material or the likes, for securing the one or more coolant lines to an bottom surface of power-link apparatus 6400. Coolant lines 7107 can include an coolant connector coupled to an coolant inflow and coolant outflow integrated into an coolant circuitry. Phase—changing coolant fluid or coolant liquid can be used as the refrigerant.

Cooling apparatus 7100 can consist of electrical connector coupled to a connector of the vehicle for the controlling process of the cooling apparatus 7100

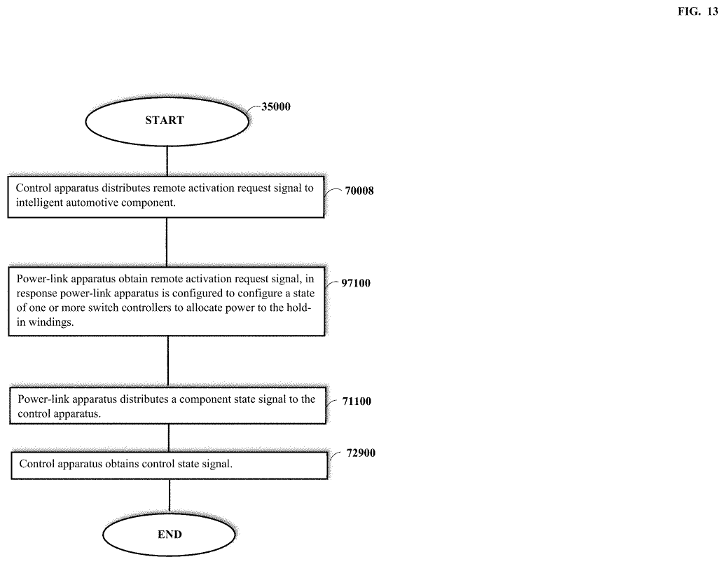

FIG. 13 is a flowchart of a process for remotely activating intelligent automotive component 1 (e.g., electric motor and/or high pressure and lift pumps) in accordance with an exemplary embodiment of present invention. In the current disclosure when the phrase “IAC Activated” is used this phrase refers to when power-signals (e.g., current) is supplied to the stator coils of the electric motor and/or pump portion of the high pressure and lift pumps of the intelligent automotive component 1, and when the phrase “IAC Deactivated” is used this phrase refers to when power-signals (e.g., current) is restricted to the stator coils of the electric motor and/or pump portion of the high pressure and lift pumps of the intelligent automotive component 1.

In method 35000 control apparatus 1000 distributes an respective activation request signal to power-link apparatus 6400 of intelligent automotive component 1 via CA transceiver 17, upon power-link apparatus 6400 obtaining the respective activation request signal via processor(s) 6, processor(s) 6 is configured to control the state of one or more switch circuits to allocate or restrict power-signals (e.g., current) to the stator coils of the electric motor and/or pump portion of the high pressure and lift pumps, and distribute one or more notifications to control apparatus 1000 via IAC transceiver 17.

Method 3500 begins with the user of control apparatus 1000 distributing an remote activation request signal (RARS) to allocate power-signals (e.g., current) to the stator coils of the electric motor and/or pump portion of the high pressure and lift pumps of intelligent automotive component(s) 1. In a preferred embodiment, an user may distribute the remote activation or deactivation request signal by physical interaction with an input button disposed on control apparatus 30 (e.g., key fob) or otherwise manipulating processing system 5 of FIG. 1 at 70008. At 97100, power-link apparatus 6400 of intelligent automotive component 1 obtains remote activation request signal (RARS) via transceiver 17. In response to obtaining the remote activation request signal (RARS) processor(s) 6 is configured to generate and distribute an first switch control signal (FSCS) to controller 42, upon power functioning controller 42 obtaining first switch control signal (FSCS) power functioning controller 42 is configured to generate and distribute an power-signal to switch circuit 3 41 to close circuitry of power-signal path 974 in order to allocate power-signals (e.g., current) to the stator coils of the electric motor and/or pump portion of the high pressure and lift pump via or gate 2.

Also, upon controller 42 obtaining first switch control signal (FSCS) controller 42 doesn't generate and distribute an signal to switch circuit 5 37 keeping the circuitry of power-signal path 975 open in order to restrict operational power (e.g., current) to processing circuit 44 via or gate 1.

More of, upon obtaining the remote activation request signal processor(s) 6 generates and distributes an second switch control signal (SSCS) to controller 20, upon power functioning controller 20 obtaining second switch control signal (SSCS) controller 20 is configured to generate and distribute an activation signal to battery module instructing battery module to distribute power-signal to switch circuit 6 45 to close the circuitry of power-signal path 976 in order to allocate operational power (e.g., current) to processing circuit 44 via or gate 1. Further, upon controller 20 obtaining second switch control signal (SSCS) controller 20 doesn't generate and distribute an power-signal to switch circuit 2 31, in response opening the circuitry of power signal path 977 in order to restrict power-signals (e.g., current) to the stator coils of the electric motor and/or pump portion of the high pressure and lift pumps via or gate 2. During this operational stage operation main power is distributed to processing circuit 44 by primary power functioning unit 3 via or gate 1.

At 71100, in response to processor(s) 6 activating intelligent automotive component 1 via distributing first switch control signal (FSCS) to controller 42 controlling the state of switch circuit 3 41 to close the circuitry of power signal path 974 allocating power-signals (e.g., current) to the stator coils of the electric motor and/or pump portion of the high pressure and lift pumps via or gate 2. Processor 6 of power-link apparatus 6400 is configure generate and distribute an component state signal (CSS) to control apparatus 1000 regarding the state of intelligent automotive component 1 under the control of processor(s) 6.

The component state signal (CSS) comprises data revealing the current status of the intelligent automotive component 1. For instance, intelligent automotive component state signal can be an notification indicating the word “IAC Activated”.

At 72900, control apparatus 1000 is configured to obtain component state signal (CSS) via CA transceiver 14 under the control of processor(s) 32, in response application 24 is configured to obtain component state signal (CSS) and display the current status of intelligent automotive component 1 on display 10, wherein the components state signal (CSS) can be the phrase “IAC Activated”. This phrase and number value may be displayed on an side panel, drop down menu or first screen of display 10, other suitable indications may be displayed to notify the user the state of intelligent automotive component 1.

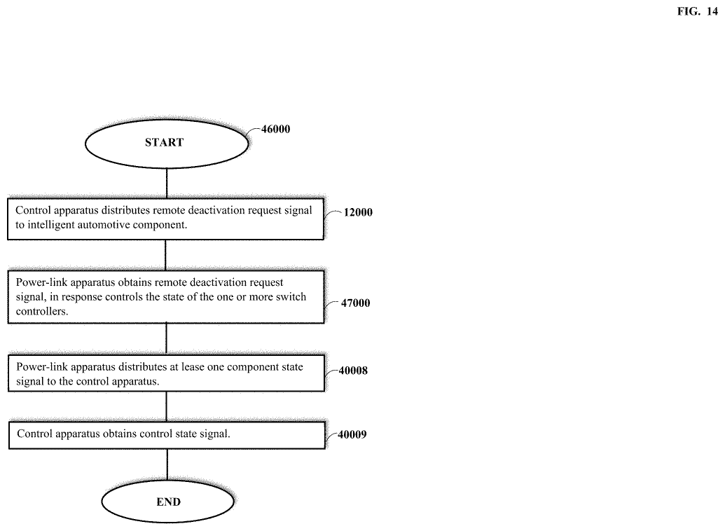

FIG. 14 is a flowchart of a process for remotely deactivating an intelligent automotive component 1 (e.g., electric motor and/or high pressure and lift pumps) in accordance with an exemplary embodiment of the present invention. The method 46000 comprises the steps of control apparatus 1000 distributing an respective remote deactivation request signal (RDRS) to power-link apparatus 6400 of intelligent automotive component 1 via CA transceiver 17, upon power-link apparatus 6400 obtaining the respective remote deactivation request signal (RDRS) processor(s) 6 is configured to control the state of one or more switch circuits to restrict power-signals (e.g., current) to the stator coils of the electric motor and/or pump portion of the high pressure and lift pumps, and to allocate power-signals (e.g., current) to processing circuitry 44, and distribute one or more notifications to control apparatus 1000.

At 12000, the user of control apparatus 1000 distributes an remote deactivation request signal (RDRS) to restrict power-signals (e.g., current) to the stator coils of the electric motor and/or pump portion of the high pressure and lift pumps of intelligent automotive component(s) 1 (step 47000). In a preferred embodiment, an user may distribute the remote deactivation request signal (RDRS) by physical interaction with an input button disposed on control apparatus 30 (e.g., key fob) or otherwise manipulating processing system 5 of FIG. 1.

At 47000, power-link apparatus 6400 of intelligent automotive component 1 obtains the respective remote deactivation request signal (RDRS) via transceiver 9. In response to obtaining the remote deactivation request signal (RDRS) processor(s) 6 generates and distributes an first switch control signal (FSCS) to controller 42, upon controller 42 obtaining first switch control signal (FSCS), controller 42 doesn't generate and distribute an power-signal to switch circuit 3 41 opening the circuitry of power signal path 974 in order to restrict voltage power (e.g., current) to the stator coils of the electric motor and/or pump portion of the high pressure and lift pumps via or gate 2. Also, controller 42 doesn't generate and distribute an signal to switch circuit 5 37 opening the circuitry of power signal path 975 in order to restrict voltage power to processing circuit 44 via or gate 1.

In addition, when power-link apparatus 6400 of intelligent automotive component 1 obtains remote deactivation request signal (RDRS) primary power functioning unit 3 distributes operational power (e.g., current) to processing circuit 44. Further, processor(s) 6 generates and distributes an second switch control signal (SSCS) to controller 20, upon controller 20 obtaining second switch control signal (SSCS) controller 20 is configured to generate and distribute an deactivation signal to battery module instructing battery module to distribute power-signal to switch circuit 6 45 to close the circuitry of power signal path 976 in order to allocate operational power (e.g., current) to processing circuit 44 via or gate 1. Also, upon controller 20 obtaining second switch control signal (SSCS) controller 20 doesn't generate and distribute an power-signal to switch circuit 2 31 opening the circuitry of power signal path 977 in order to restrict power-signals to the stator coils of the electric motor and/or pump portion of the high pressure and lift pumps via or gate 2.

At 40008, in response to processor(s) 6 deactivating intelligent automotive component 1 via distributing an first switch control signal (FSCS) to controller 42 controlling the state of switch circuit 3 41 opening the circuitry of power signal path 974 restricting power-signals (e.g., current) to the stator coils of the electric motor and/or pump portion of the high pressure and lift pumps via or gate 2, and distributing an second switch control signal (SSCS) to controller 20 restricting power-signals (e.g., current) to the stator coils of the electric motor and/or pump portion of the high pressure and lift pumps via or gate 2 by way of controlling the state of switch circuit 2 31 opening the circuitry of power signal path 977 in order to restrict voltage power (e.g., current) to or gate 2.

Power-link apparatus 6400 of intelligent automotive component 1 generates and distributes an respective component state signal (CSS) to control apparatus 1000 regarding the status of intelligent automotive component 1 under the control of one or more processor(s) 6.

For instance, the component state signal is an notification indicating the word “IAC Deactivated”.

At 40009, control apparatus 1000 is configured to obtain the component state signal (CSS) via CA transceiver 17 under the control of one or more processor(s) 32, in response processor(s) 32 is configured to obtain the component state signal (CSS) and display the current status of intelligent automotive component 1 on display 10, wherein during deactivation component state signal (CSS) is the phrase “IAC Deactivated”. This phrase may be displayed on an side panel, drop down menu or first screen of display 10, other suitable indications may be displayed to notify the user the state of intelligent automotive component 1.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the present invention may included variations in size shape form function and manner of operation. The assembly and use of the present invention are deemed readily apparent and obvious to one skilled in the art.

1. A intelligent automotive component comprising:
a motor comprising an stator, wherein the stator consist of an member coupled to an obverse rim surface for housing a power-link apparatus, wherein the member of said stator further consist of one or more slot for receiving a head coil end projecting from an stator coil and an coolant line of a cooling apparatus, wherein the head coil end of stator coil is coupled to a signal path of said power-link apparatus; and wherein said stator consist of an coolant apparatus coupled to an surface of an housing of said stator;
a control apparatus configured to distribute an signal to the power-link apparatus;
one or more switch disposed on a circuitry of said power-link apparatus, and wherein the one or more switches operate at an on and off state based upon a processor of said power-link apparatus obtaining an remote activation signal and remote deactivation signal via a control apparatus; and
wherein the stator comprises a coil connector, wherein said coil connector comprise an input/output terminal, wherein input/output terminal consist of an u-phase terminal, w-phase terminal and v-phase terminal communicable coupled to the signal path of said power-link apparatus to obtain and distribute signals between said power-link apparatus and PWM inverter based upon a control apparatus distributing an remote activation or deactivation signal to a processor of said power-link apparatus;
wherein said head coil end communicable coupled to the power-signal path of said power-link apparatus is configured to obtain and distribute power-signals between said power-link apparatus and the stator coil to provide torque to a wheel of a vehicle based upon the processor of said power-link apparatus obtaining the remote activation and deactivation request signal via the control apparatus;
wherein said head coil end is configured to distribute power-signals to the stator coils to provide torque to the wheel of the vehicle based upon the processor of said power-link apparatus obtaining the remote activation signal via the control apparatus, and wherein the processor of the power-link apparatus is configured to generate and distribute an first switch control signal to a controller, wherein upon a controller obtaining the first switch control signal the controller is configured to generate and distribute the power-signal to a third switch circuit to close the circuitry of a power-signal path in order to allocate the power-signals to the stator coils via a second gate;
wherein said processor of power-link apparatus is further configured to generate and distribute an second switch control signal to the controller upon obtaining the remote activation request signal, wherein the controller is configured to generate and distribute an activation signal to battery module instructing battery module to distribute the power-signal to the six switch circuit to close the circuitry of the power-signal path in order to allocate operational power to a processing circuit via the first gate;
wherein the processor of said power-link apparatus is further configure to generate and distribute an component state signal to the control apparatus regarding an state of the intelligent automotive component based upon the processor of said power-link apparatus obtaining the remote activation request signal;
wherein head coil end is configured to restrict power-signal to the stator coils to restrict torque to the wheel of the vehicle based upon said processor of the power-link apparatus obtaining the remote deactivation request signal via said control apparatus, and wherein the processor of the power-link apparatus is configured to generate and distribute the first switch control signal to the controller,
wherein upon the controller obtaining the first switch control signal the controller doesn't generate and distribute the power-signal to the third switch circuit to open the circuitry of the power-signal path in order to restrict voltage power to the stator coils of the motor via the second gate;
wherein said processor of power-link of apparatus is further configured to generate and distribute the second switch control signal to the controller upon obtaining the remote deactivation request signal, wherein the controller is configured to generate and distribute an deactivation signal to the battery module instructing battery module to distribute the power-signal to the six switch circuit to close the circuitry of the power-signal path in order to allocate operational power to the processing circuit via the first gate;
wherein said processor of the power-link apparatus is further configured to generate and distribute an component state signal to said control apparatus regarding the an state of the intelligent automotive component based upon the processor of said power-link apparatus obtaining the remote deactivation request signal;
wherein the vehicle comprises an electric motor relay configured to allocate the power-signal to be perpetually distributed to said motor in order to keep currents supplied to power-link apparatus weather if the ignition/push button is at an OFF, RUN, START position.

2. The intelligent automotive component of claim 1, wherein the motor is an brushless motor

3. The intelligent automotive component of claim 1, wherein the control apparatus is an terminal.

4. The intelligent automotive component of claim 1, wherein the head coil end obtains and distribute power-signals between the V-phase coils, W-phase coils, and U-phase coils and the power-link apparatus.

5. A method for remotely activating an intelligent automotive component, the method comprising:
obtaining, by one or more processors of a power-link apparatus, an respective remote activation request signal via a control apparatus, and wherein upon the one or more processors of the power-link apparatus obtaining the remote activation request signal the one or more processors of said power-link apparatus is configured to generate and distribute a first switch control signal to an controller of a secondary power functioning unit, and wherein the controller of said secondary power functioning unit is configured to distribute an power-signal to a third switch circuit to allocate the power-signals to an stator-coil via an head coil end via a second gate, wherein a switch of the third switch circuit closes the power-signal path of the third switch circuit, and wherein also upon the controller of said secondary power functioning unit obtaining the first switch control signal the controller doesn't distribute the power signal to the fifth switch circuit opening the power signal path in order to restrict the power signals to a processing circuit via the first gate; and wherein upon the one or more processors of the power-link apparatus obtaining the remote activation request signal the one or more processors of the power-link apparatus is configured to generate and distribute the second switch control signal to the controller of a primary power functioning unit, and wherein the controller of said primary power functioning unit is configured to distribute a activation signal to a battery module instructing battery module to distribute the power-signal to the six switch circuit closing the power signal path allocating the power signal to the processing circuit via the first gate; and wherein upon the controller of the primary power functioning unit obtaining the second switch control signal the controller doesn't distribute the power signal to the second switch circuit opening the switch of the second switch circuit restricting the power-signal to said head end coil via the second gate; and
distributing, by the one or more processors of the power-link apparatus, a component state signal to the control apparatus to notify a user of the control apparatus a current state of the intelligent automotive component.

6. A method for remotely deactivating a intelligent automotive component, the method comprising:
obtaining, by one or more processors of a power-link apparatus, a remote deactivation request signal via a control apparatus, and wherein upon the one or more processors of the power-link apparatus obtaining the remote deactivation request signal the one or more processors of the power-link apparatus is configured to generate and distribute an first switch control signal to a controller of a secondary power functioning unit, and wherein the controller of said secondary power functioning unit doesn't distribute an power signal to a third switch circuit restricting an power signal to a head end coil via a second gate, wherein a switch of the third switch circuit opens the power signal path of the third switch circuit; and wherein also upon the controller of the secondary power obtaining the first switch control signal the controller doesn't distribute the power signal to the fifth switch circuit wherein the switch of the fifth switch circuit opens the power signal path of the fifth switch circuit in order to restrict power signals to a processing circuit via the first gate; and wherein upon the one or more processors of the power-link apparatus obtaining the remote deactivation request signal the one or more processors of the power-link apparatus is configured to generate and distribute the second switch control signal to the controller of an primary power functioning unit, and wherein the controller of said primary power functioning unit is configured to distribute an deactivation signal to a battery module instructing battery module to distribute the power-signal to the processing circuit via the first gate, wherein the switch of said six switch circuit closes the power signal path of the six switch circuit; and wherein upon the controller of said primary power functioning unit obtaining the second switch control signal the controller doesn't distribute the power-signal to said second switch circuit wherein the switch of said second switch circuit opens the power signal path of the second switch circuit in order to restrict the power signals to the head end coil via the second gate; and
distributing, by the one or more processors of said power-link apparatus, a component state signal to the control apparatus to notify a user of the control apparatus a current state of the intelligent automotive component.
